(19) United States
(12) Patent Application Publication
(10) Pub. No.: US 2008/0249870 A1
(43) Pub. Date: Oct. 9, 2008

(54) METHOD AND APPARATUS FOR DECISION TREE BASED MARKETING AND SELLING FOR A RETAIL STORE

(76) Inventors: Robert Lee Angell, Salt Lake City, UT (US); James R. Kraemer, Santa Fe, NM (US)

Correspondence Address: DUKE W. YEE, YEE AND ASSOCIATES, P.C., P.O. BOX 802333, DALLAS, TX, 75380, US

(21) Appl. No.: 11/862,374

(22) Filed: Sep. 27, 2007

Related U.S. Application Data
(63) Continuation-in-part of application No. 11/695,983, filed on Apr. 3, 2007.

(51) Int. Cl. G06Q 30/00; G06F 17/30

(52) U.S. Cl. 705/14

(57) ABSTRACT

A computer implemented method, apparatus, and computer usable program product for decision tree based marketing to a customer in a retail facility. In response to identifying a customer associated with the retail facility, a marketing decision tree for the customer is retrieved. The marketing decision tree indicates a set of paths through the retail facility that the customer will most likely follow while shopping. A next probable location of the customer is identified using a current location of the customer and the marketing decision tree. A customized marketing message for an item located in the next probable location is presented to the customer.

### CROSS-REFERENCE TO RELATED APPLICATIONS

This application is a continuation-in-part of patent application U.S. Ser. No. 11/695,983, filed Apr. 3, 2007, titled “Method and Apparatus for Providing Customized Digital Media Marketing Content Directly to a Customer”, which is incorporated herein by reference.

The present invention is also related to the following applications entitled Identifying Significant Groupings of Customers for Use in Customizing Digital Media Marketing Content Provided Directly to a Customer, application Ser. No. 11/744,024, filed May 3, 2007; Generating Customized Marketing Messages at a Customer Level Using Current Events Data, application Ser. No. 11/769,409, file Jun. 24, 2007; Generating Customized Marketing Messages Using Automatically Generated Customer Identification Data, application Ser. No. 11/756,198, filed May 31, 2007; Generating Customized Marketing Messages for a Customer Using Dynamic Customer Behavior Data, application Ser. No. 11/771,252, filed Jun. 29, 2007, Retail Store Method and System, Robyn Schwartz, Publication No. US 2006/0032915 A1 (filed Aug. 12, 2004); Business Offering Content Delivery, Robyn R. Levine, Publication No. US 2002/0111852 (filed Jan. 16, 2001) all assigned to a common assignee, and all of which are incorporated herein by reference.

### BACKGROUND OF THE INVENTION

1. Field of the Invention

The present invention is related generally to an improved data processing system and in particular to a method and apparatus for processing data. More particularly, the present invention is directed to a computer implemented method, apparatus, and computer usable program product for dynamically presenting marketing content to a customer based on a marketing decision tree for the customer.

2. Description of the Related Art

In the past, merchants, owners and operators of stores frequently had a personal relationship with their customers. The merchant often knew their customers' names, address, marital status, ages of their children, hobbies, place of employment, anniversaries, birthdays, likes, dislikes, and personal preferences. The merchant might be aware of projects that a particular customer is planning and/or the types of meals that the customer prefers to prepare. In addition, the customer was generally very familiar with the merchant and the layout of the retail facility. The customer might discuss their favorite recipes or upcoming projects with the merchant to obtain advice as to which ingredients or items to purchase, where the ingredients or items are located in the store, and other helpful information.

However, with the continued growth of large cities, the corresponding disappearance of small, rural towns, and the increasing number of large, impersonal chain stores with multiple employees, the merchants and employees of retail businesses rarely recognize regular customers, and almost never know the customer's name or any other details regarding their customer's personal preferences, projects, or plans that might assist the merchant or employee in marketing efforts directed toward a particular customer. In addition, customers are frequently unfamiliar with the locations of desired items and the anonymity of big box stores tends to deter these customers from seeking advice or assistance from merchants. Moreover, it can be expensive for merchants to hire a sufficient number of employees to assist customers, give directions, and offer advice as to what items may be needed and where the items can be found in the store as the customers are shopping.

Currently, computers can be used to generate static marketing messages for customers based on user profile data, such as demographic data, point of contact data, and past transaction data. These marketing messages are generally mailed or emailed to customers at their home. However, current solutions do not utilize all of the potential dynamic customer data elements that may be available to a retail owner or operator for generating customized marketing messages targeted to individual customers. For example, the marketing offers do not provide information regarding locations of items or anticipate items and locations in the retail facility of interest to the customer. Other data pieces are needed to provide effective dynamic 1:1 marketing and guided selling to the potential customer. Therefore, the data elements in prior art only provide approximately seventy-five percent (75%) of the needed data.

### SUMMARY OF THE INVENTION

The illustrative embodiments provide a computer implemented method, apparatus, and computer usable program product for decision tree based marketing to a customer in a retail facility. In one embodiment, the process retrieves a marketing decision tree for the customer in response to identifying a customer associated with the retail facility. The marketing decision tree indicates a set of paths through the retail facility that the customer will most likely follow while shopping. A next probable location of the customer is identified using a current location of the customer and the marketing decision tree. A customized marketing message for an item located in the next probable location is presented to the customer.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a digital customer marketing environment in which illustrative embodiments may be implemented;

FIG. 3 is a block diagram of a data processing system in which illustrative embodiments may be implemented;

FIG. 4 is a block diagram of a data processing system for analyzing dynamic customer data in accordance with an illustrative embodiment;

FIG. 5 is a block diagram of a shelf in a retail facility in accordance with an illustrative embodiment;

FIG. 6 is a block diagram of a shopping container in accordance with an illustrative embodiment;

FIG. 7 is a block diagram of a dynamic marketing message assembly transmitting a customized marketing message to a set of display devices in accordance with an illustrative embodiment;

FIG. 8 is a block diagram of an identification tag reader for identifying items selected by a customer in accordance with an illustrative embodiment;

FIG. 9 is a block diagram illustrating a smart detection engine for generating customer identification data and selected item data in accordance with an illustrative embodiment;

FIG. 10 is a block diagram illustrating a marketing decision tree in accordance with an illustrative embodiment;

FIG. 11 is a block diagram illustrating a path in a marketing decision tree in accordance with an illustrative embodiment;

FIG. 12 is a block diagram of a representation of the retail facility showing the location of items in the retail facility in accordance with an illustrative embodiment;

FIG. 13 is a flowchart illustrating a process for using a marketing decision tree to identify a next location of the customer in accordance with an illustrative embodiment;

FIG. 14 is a flowchart illustrating a process for generating a marketing message using a marketing decision tree in accordance with an illustrative embodiment;

FIG. 15 is a flowchart illustrating a process for generating a representation of the retail facility in accordance with an illustrative embodiment;

FIG. 16 is a flowchart illustrating a process for marketing to a customer using a marketing decision tree in accordance with an illustrative embodiment;

FIG. 17 is a flowchart illustrating a process for generating a marketing decision tree in accordance with an illustrative embodiment;

FIG. 18 is a flowchart illustrating a process for generating customer identification data in accordance with an illustrative embodiment;

FIG. 19 is a flowchart illustrating a process for generating customer identification data using vehicle data in accordance with an illustrative embodiment; and

FIG. 20 is a flowchart illustrating a process for generating a project based customized marketing message using dynamic data in accordance with an illustrative embodiment.

### DETAILED DESCRIPTION OF THE PREFERRED EMBODIMENT

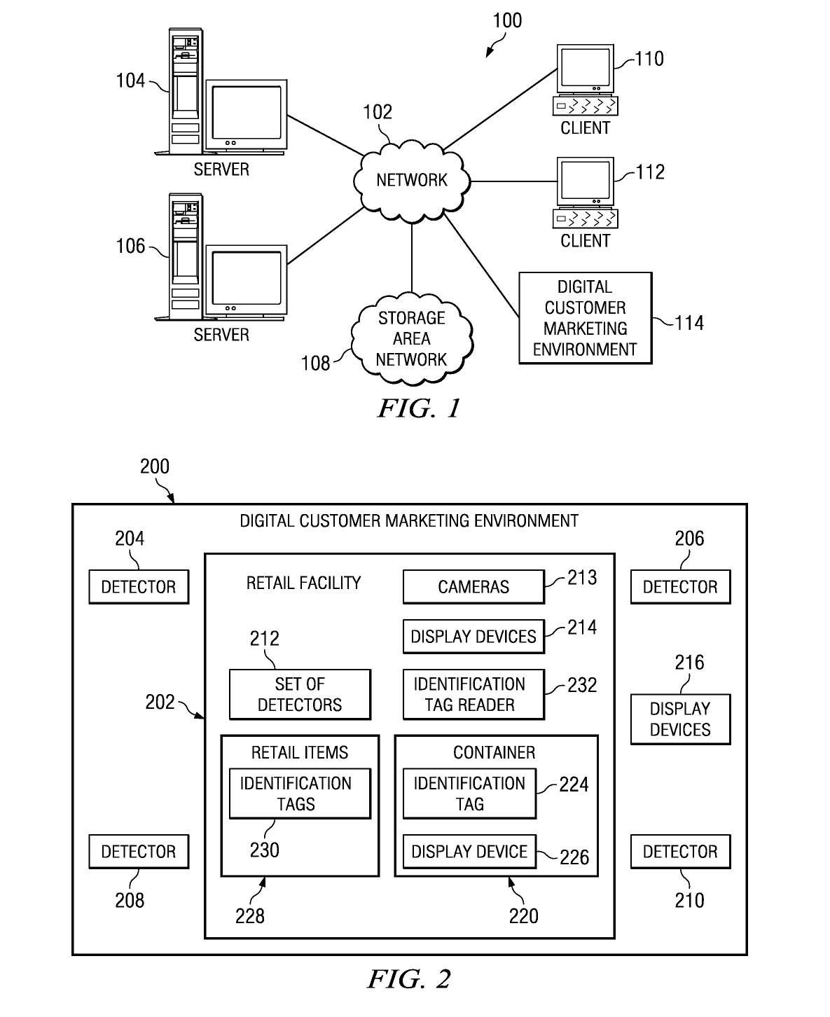

With reference now to the figures and in particular with reference to FIGS. 1-3, exemplary diagrams of data processing environments are provided in which illustrative embodiments may be implemented. It should be appreciated that FIGS. 1-3 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage area network (SAN) 108. Storage area network 108 is a network connecting one or more data storage devices to one or more servers, such as servers 104 and 106. A data storage device, may include, but is not limited to, tape libraries, disk array controllers, tape drives, flash memory, a hard disk, and/or any other type of storage device for storing data. Storage area network 108 allows a computing device, such as client 110 to connect to a remote data storage device over a network for block level input/output.

In addition, clients 110 and 112 connect to network 102. These clients 110 and 112 may be, for example, personal computers or network computers. In the depicted example, server 104 provides data, such as boot files, operating system images, and applications to clients 110 and 112. Clients 110 and 112 are clients to server 104 in this example.

Digital customer marketing environment 114 is a retail environment that is connected to network 102. A customer may view, select order, and/or purchase one or more items in digital customer marketing environment 114. Digital customer marketing environment 114 may include one or more facilities, buildings, or other structures for wholly or partially containing items.

The items in digital customer marketing environment 114 may include, but are not limited to, consumables, comestibles, clothing, shoes, toys, cleaning products, household items, machines, any type of manufactured items, entertainment and/or educational materials, as well as entrance or admittance to attend or receive an entertainment or educational activity or event. Items for purchase could also include services, such as, without limitation, dry cleaning services, food delivery services, automobile repair services, vehicle detailing services, personal grooming services, such as manicures and haircuts, cooking demonstrations, or any other services.

Comestibles include solid, liquid, and/or semi-solid food and beverage items. Comestibles may be, but are not limited to, meat products, dairy products, fruits, vegetables, bread, pasta, pre-prepared or ready-to-eat items, as well as unprepared or uncooked food and/or beverage items. For example, a comestible includes, without limitation, a box of cereal, a steak, tea bags, a cup of tea that is ready to drink, popcorn, pizza, candy, or any other edible food or beverage items.

An entertainment or educational activity, event, or service may include, but is not limited to, a sporting event, a music concert, a seminar, a convention, a movie, a ride, a game, a theatrical performance, and/or any other performance, show, or spectacle for entertainment or education of customers. For example, entertainment or educational activity or event could include, without limitation, the purchase of seating at a football game, purchase of a ride on a roller coaster, purchase of a manicure, or purchase of admission to view a film.

Digital customer marketing environment 114 may also includes a parking facility for parking cars, trucks, motorcycles, bicycles, or other vehicles for conveying customers to and from digital customer marketing environment 114. A parking facility may include an open air parking lot, an underground parking garage, an above ground parking garage, an automated parking garage, and/or any other area designated for parking customer vehicles.

For example, digital customer marketing environment 114 may be, but is not limited to, a grocery store, a retail store, a department store, an indoor mall, an outdoor mall, a combination of indoor and outdoor retail areas, a farmer's market, a convention center, a sports arena or stadium, an airport, a bus depot, a train station, a marina, a hotel, fair grounds, an amusement park, a water park, and/or a zoo.

Digital customer marketing environment 114 encompasses a range or area in which marketing messages may be transmitted to a digital display device for presentation to a customer within digital customer marketing environment. Digital multimedia management software is used to manage and/or enable generation, management, transmission, and/or display of marketing messages within digital customer marketing environment. Examples of digital multimedia management software include, but are not limited to, Scala® digital media/digital signage software, EK3® digital media/digital signage software, and/or Allure digital media software.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as, without limitation, an intranet, an Ethernet, a local area network (LAN), and/or a wide area network (WAN).

Network data processing system 100 may also include additional data storage devices in addition to or instead of storage area network 108, such as, without limitation, one or more hard disks, compact disks (CD), compact disk rewritable (CD-RW), flash memory, compact disk read-only memory (CD ROM), non-volatile random access memory (NV-RAM), and/or any other type of storage device for storing data.

FIG. 1 is intended as an example, and not as an architectural limitation for different embodiments. Network data processing system 100 may include additional servers, clients, data storage devices, and/or other devices not shown. For example, server 104 may also include devices not depicted in FIG. 1, such as, without limitation, a local data storage device.

In another embodiment, digital customer marketing environment 114 includes one or more servers located on-site at digital customer marketing environment. In this example, network 102 is optional. In other words, if one or more servers and/or data processing systems are located at digital customer marketing environment 114, the illustrative embodiments are capable of being implemented without requiring a network connection to computers located remotely to digital customer marketing environment 114.

A merchant, owner, operator, manager or other employee associated with digital customer marketing environment 114 typically wants to market products or services to customers in the most convenient and efficient manner possible so as to maximize resulting purchases by the customer and increase sales, profits, and/or revenue. Therefore, the aspects of the illustrative embodiments recognize that it is advantageous for the merchant to have as much information as possible describing one or more customers and to anticipate items that the customer may wish to purchase prior to the customer selecting those items for purchase in order to identify the best items to market to the customer and personalize the merchant's marketing strategy to that particular customer.

Therefore, the illustrative embodiments provide a computer implemented method, apparatus, and computer program product for decision tree based marketing to a customer in a retail facility. In one embodiment, the process retrieves a marketing decision tree for the customer in response to identifying a customer associated with the retail facility. The marketing decision tree includes a path through the retail facility that the customer typically follows while shopping and a list of customarily purchased items. The list of customarily purchased items is a list of items that the customer frequently or habitually purchases when shopping.

A next probable location of the customer is identified using a current location of the customer and the marketing decision tree. The next probable location is a location or area that the customer is not currently occupying, but is a predicted location or area in which the customer will soon be occupying in the near future.

The marketing decision tree indicates the most likely path through the retail facility that the customer will follow while shopping based on the current location. In other words, the marketing decision tree provides a predicted path or route through the retail store that the customer is most likely to take based on the routes taken through the retail store on previous occasions by the customer, the items that the customer frequently purchases, and the customer's current location in the retail store.

For example, if the customer is located at the end of an aisle containing frozen foods and the customer frequently purchases ice cream while shopping in the past, the marketing decision tree predicts that the next location for the customer is the section of the frozen foods aisle that contains ice cream. The marketing decision tree can even predict the specific brand, flavor, and/or size of ice cream the customer is likely to select and the exact location of the brand, flavor and/or size of the ice cream in the freezer in the frozen food aisle.

A customized marketing message for an item located in the next probable location is presented to the customer. In the example given above, the customized marketing message is a marketing offer for ice cream. The marketing offer may be an offer for the brand, flavor, and size of ice cream the customer typically purchases or the marketing message may contain an offer for a different brand, a different flavor, and/or a different size of ice cream to encourage the customer to try a new product, a more expensive product, or otherwise increase purchases by the customer.

In another embodiment, the customized marketing message is a message providing the location of the item. In the example above, the customized marketing message includes the exact location of the brand, flavor, and/or size of ice cream that the customer typically purchases. In another embodiment, the customized marketing message provides a location of ice cream generally and provides marketing content for a specific brand, flavor, and/or size of ice cream. The specific brand, flavor, and/or size of ice cream may be the brand, flavor, and/or size of ice cream that the customer typically purchases or a different brand, flavor, and/or size of ice cream than the customer typically purchases.

In another embodiment, the process directs an employee to the next probable location to assist the customer. In other words, if the process determines that the next probable location of the customer is the television section, the process will direct a sales associate or other employee in the electronics department to move to the next probable location in order to assist the customer.

FIG. 2 is a block diagram of a digital customer marketing environment in which illustrative embodiments may be implemented. Digital customer marketing environment 200 is a marketing environment, such as digital customer marketing environment 114 in FIG. 1.

Retail facility 202 is a facility for wholly or partially storing, enclosing, or displaying items for marketing, viewing, selection, order, and/or purchase by a customer. For example, retail facility 202 may be, without limitation, a retail store, supermarket, grocery store, a marketplace, a food pavilion, a book store, clothing store, department store, or shopping mall. Retail facility 202 may also include, without limitation, a sports arena, amusement park, water park, convention center, trade center, or any other facility for housing, storing, displaying, offering, providing, and/or selling items. In this example, retail facility 202 is a grocery store or a department store.

Detectors 204-210 are devices for gathering data associated with a set of customers, including, but not limited to, at least one camera, motion sensor device/motion detector, sonar detection device, microphone, sound/audio recording device, audio detection device, a voice recognition system, a heat sensor/thermal sensor, a seismograph, a pressure sensor, a device for detecting odors, scents, and/or fragrances, a radio frequency identification (RFID) tag reader, a global positioning system (GPS) receiver, and/or any other detection device for detecting a presence of a human, animal, object, and/or vehicle located outside of retail facility 202. A set of customers is a set of one or more customers. A vehicle is any type of vehicle for conveying people, animals, or objects to a destination. A vehicle may include, but is not limited to, a car, bus, truck, motorcycle, boat, airplane, or any other type of vehicle.

A heat sensor is any known or available device for detecting heat, such as, but not limited to, a thermal imaging device for generating images showing thermal heat patterns. A heat sensor can detect body heat generated by a human or animal and/or heat generated by a vehicle, such as an automobile or a motorcycle. A set of heat sensors may include one or more heat sensors.

A motion detector may be implemented in any type of known or available motion detector device. A motion detector device may include, but is not limited to, one or more motion detector devices using a photo-sensor, radar or microwave radio detector, or ultrasonic sound waves.

A motion detector using ultrasonic sound waves transmits or emits ultrasonic sound waves. The motion detector detects or measures the ultrasonic sound waves that are reflected back to the motion detector. If a human, animal, or other object moves within the range of the ultrasonic sound waves generated by the motion detector, the motion detector detects a change in the echo of sound waves reflected back. This change in the echo indicates the presence of a human, animal, or other object moving within the range of the motion detector.

In one example, a motion detector device using a radar or microwave radio detector may detect motion by sending out a burst of microwave radio energy and detecting the same microwave radio waves when the radio waves are deflected back to the motion detector. If a human, animal, or other object moves into the range of the microwave radio energy field generated by the motion detector, the amount of energy reflected back to the motion detector is changed. The motion detector identifies this change in reflected energy as an indication of the presence of a human, animal, or other object moving within the motion detectors range.

A motion detector device, using a photo-sensor, detects motion by sending a beam of light across a space into a photo-sensor. The photo-sensor detects when a human, animal, or object breaks or interrupts the beam of light as the human, animal, or object by moving in-between the source of the beam of light and the photo-sensor. These examples of motion detectors are presented for illustrative purposes only. A motion detector in accordance with the illustrative embodiments may include any type of known or available motion detector and is not limited to the motion detectors described herein.

A pressure sensor detector may be, for example, a device for detecting a change in weight or mass associated with the pressure sensor. For example, if one or more pressure sensors are imbedded in a sidewalk, Astroturf, or floor mat, the pressure sensor detects a change in weight or mass when a human customer or animal steps on the pressure sensor. The pressure sensor may also detect when a human customer or animal steps off of the pressure sensor. In another example, one or more pressure sensors are embedded in a parking lot, and the pressure sensors detect a weight and/or mass associated with a vehicle when the vehicle is in contact with the pressure sensor. A vehicle may be in contact with one or more pressure sensors when the vehicle is driving over one or more pressure sensors and/or when a vehicle is parked on top of one or more pressure sensors.

Camera 212 is an image capture device that may be implemented as any type of known or available camera, including, but not limited to, a video camera for taking moving video images, a digital camera capable of taking still pictures and/or a continuous video stream, a stereo camera, a web camera, and/or any other imaging device capable of capturing a view of whatever appears within the camera's range for remote monitoring, viewing, or recording of a distant or obscured person, object, or area.

Various lenses, filters, and other optical devices such as zoom lenses, wide angle lenses, mirrors, prisms and the like may also be used with camera 212 to assist in capturing the desired view. Camera 212 may be fixed in a particular orientation and configuration, or it may, along with any optical devices, be programmable in orientation, light sensitivity level, focus or other parameters. Programming data may be provided via a computing device, such as server 104 in FIG. 1.

Camera 212 may also be a stationary camera and/or non-stationary camera. A non-stationary camera is a camera that is capable of moving and/or rotating along one or more directions, such as up, down, left, right, and/or rotate about an axis of rotation. Camera 212 may also be capable of moving to follow or track a person, animal, or object in motion. In other words, the camera may be capable of moving about an axis of rotation in order to keep a customer, animal, or object within a viewing range of the camera lens. In this example, detectors 204-210 are non-stationary digital video cameras.

Camera 212 may be located, without limitation, at an entrance to retail facility 202, on one or more shelves in retail facility 202, coupled to a wall, associated with an employee, a camera mounted on a robot, a camera mounted on a cart or dolly, a camera mounted at a point of sale, mounted on one or more doors or doorways in retail facility, or located anywhere in retail facility 202.

Camera 212 may be coupled to and/or in communication with the analysis server. In addition, more than one image capture device may be operated simultaneously without departing from the illustrative embodiments of the present invention.

In this example, detectors 204-210 are located at locations along an outer perimeter of digital customer marketing environment 200. However, detectors 204-210 may be located at any position outside retail facility 202 to detect customers before the customers enter retail facility 202 and/or when customers exit retail facility 202.

Detectors 204-210 are connected to an analysis server on a data processing system, such as network data processing system 100 in FIG. 1. The analysis server is illustrated and described in greater detail in FIG. 6 below. The analysis server includes software for analyzing digital images and other data captured by detectors 204-210 to track and/or visually identify retail items, containers, and/or customers outside retail facility 202. Attachment of identifying marks may be part of this visual identification in the illustrative embodiments.

In this example, four detectors, detectors 204-210, are located outside retail facility 202. However, any number of detectors may be used to detect, track, and/or gather dynamic data associated with customers outside retail facility 202. For example, a single detector, as well as two or more detectors may be used outside retail facility 202 for tracking customers entering and/or exiting retail facility 202. The dynamic customer data gathered by the one or more detectors in detectors 204-210 is referred to herein as external data.

Retail facility 202 may also optionally include set of detectors 212 inside retail facility 202. Set of detectors 212 is a set of one or more detectors, such as detectors 204-210. Set of detectors 212 are detectors for gathering dynamic data inside retail facility 202. The dynamic data gathered by set of detectors 212 includes, without limitation, grouping data, identification data, and/or customer behavior data. The dynamic data associated with a customer that is captured by one or more detectors in set of detectors 212 is referred to herein as internal data.

Set of detectors 212 may be located at any location within retail facility 202. In addition, set of detectors 212 may include multiple detectors located at differing locations within retail facility 202. For example, a detector in set of detectors 212 may be located, without limitation, at an entrance to retail facility 202, on one or more shelves in retail facility 202, and/or on one or more doors or doorways in retail facility 202. In one embodiment, set of detectors 212 includes one or more cameras or other image capture devices for tracking and/or identifying items, containers for items, shopping containers, customers, shopping companions of the customer, shopping carts, and/or store employees inside retail facility 202.

In one example, images of the customer are captured by a set of three or more cameras in the set of detectors 212. The camera images captured by these three or more cameras are processed to form dynamic data for the customer. The dynamic data includes a three-dimensional representation of the customer in the retail facility. The representation includes data describing the customer at the current location of the customer in the retail facility. Thus, the representation is used to identify the current location of the customer.

Display devices 214 are multimedia devices for displaying marketing messages to customers. Display devices 214 may be any type of display device for presenting a text, graphic, audio, video, and/or any combination of text, graphics, audio, and video to a customer. In this example, display devices 214 are located inside retail facility 202. Display devices 214 may be one or more display devices located within retail facility 202 for use and/or viewing by one or more customers. The images shown on display devices 214 are changed in real time in response to various events such as, without limitation, the time of day, the day of the week, a particular customer approaching the shelves or rack, items already placed inside container 220 by the customer, and dynamic data for the customer.

Display devices 216 are located outside retail facility 216 include at least one display device. The display device(s) may be, without limitation, a display screen or a kiosk located in a parking lot, queue line, and/or other area outside of retail facility 202. Display devices 216 outside retail facility 202 may be used in the absence of display devices 214 inside retail facility 202 or in addition to display devices 214.

Display device 226 may be operatively connected to a data processing system via wireless, infrared, radio, or other connection technologies known in the art, for the purpose of transferring data to be displayed on display device 226. The data processing system includes the analysis server for analyzing dynamic external customer data obtained from detectors 204-210 and set of detectors 212, as well as static customer data obtained from one or more databases storing data associated with customers.

Container 220 is a container for holding, carrying, transporting, or moving one or more items. For example, container 220 may be, without limitation, a shopping cart, a shopping bag, a shopping basket, and/or any other type of container for holding items. In this example, container 220 is a shopping cart. In this example in FIG. 2, only one container 220 is depicted. However, any number of containers may be used inside and/or outside retail facility 202 for holding, carrying, transporting, or moving items selected by customers.

Container 220 may also optionally include identification tag 224. Identification tag 224 is a tag for identifying container 220, locating container 220 within digital customer marketing environment 200, either inside or outside retail facility 202, and/or associating container 220 with a particular customer. For example, identification tag 224 may be a radio frequency identification (RFID) tag, a universal product code (UPC) tag, a global positioning system (GPS) tag, and/or any other type of identification tag for identifying, locating, and/or tracking a container.

Container 220 may also include display device 226 coupled to, mounted on, attached to, or imbedded within container 220. Display device 226 is a multimedia display device for displaying textual, graphical, video, and/or audio marketing messages to a customer. For example, display device 226 may be a digital display screen or personal digital assistant attached to a handle, front, back, or side member of container 220.

Container 220 may optionally include an identification tag reader (not shown) for receiving data from identification tags 230 associated with retail items 228. Retail items 228 are items of merchandise for sale. Retail items 228 may be displayed on a display shelf (not shown) located in retail facility 202. Other items of merchandise may be for sale, such as, without limitation, food, beverages, shoes, clothing, household goods, decorative items, or sporting goods, may be hung from display racks, displayed in cabinets, on shelves, or in refrigeration units (not shown). Any other type of merchandise display arrangement known in the retail trade may also be used in accordance with the illustrative embodiments. For example, display shelves or racks may include, in addition to retail items 228, various advertising displays, images, or postings.

Retail items 228 may be viewed or identified by the illustrative embodiments using an image capture device or other detector in set of detectors 212. To facilitate identification, items may have attached identification tags 230. Identification tags 230 are tags associated with one or more retail items for identifying the item and/or location of the item. For example, identification tags 230 may be, without limitation, a bar code pattern, such as a universal product code (UPC) or European article number (EAN), a radio frequency identification (RFID) tag, or other optical identification tag, depending on the capabilities of the image capture device and associated data processing system to process the information and make an identification of retail items 228. In some embodiments, an optical identification may be attached to more than one side of a given item.

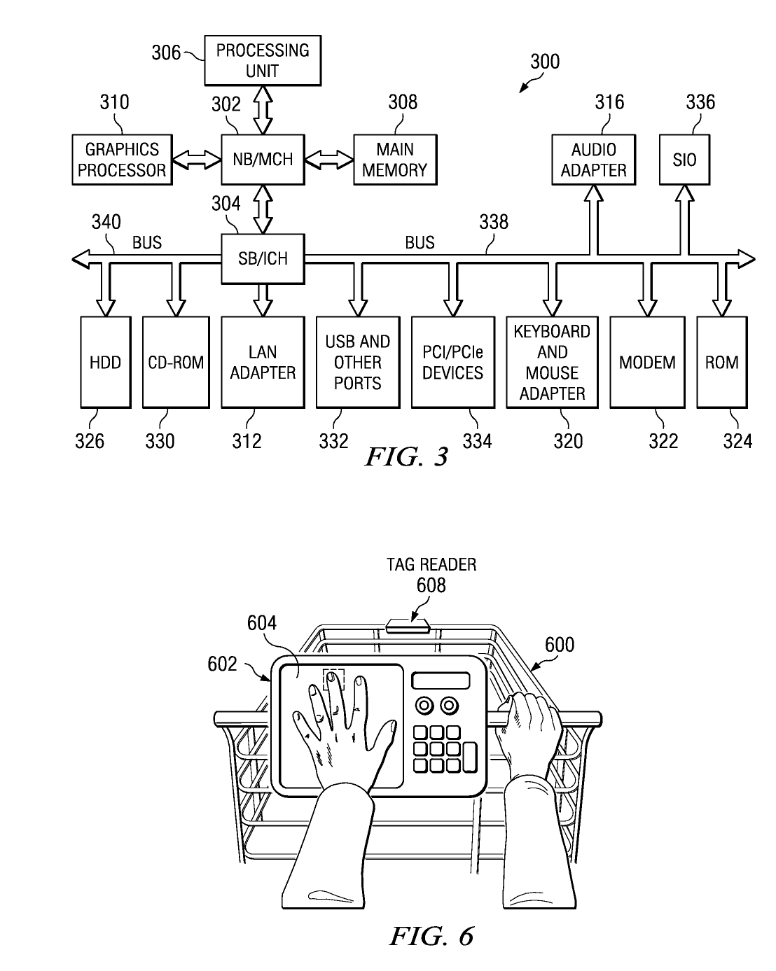

The data processing system, discussed in greater detail in FIG. 3 below, includes associated memory which may be an integral part, such as the operating memory, of the data processing system or externally accessible memory. Software for tracking objects may reside in the memory and run on the processor. The software is capable of tracking retail items 228, as a customer removes an item in retail items 228 from its display position and places the item into container 220. Likewise, the tracking software can track items which are being removed from container 220 and placed elsewhere in the retail store, whether placed back in their original display position or anywhere else including into another container. The tracking software can also track the position of container 220 and the customer.

The software can track retail items 228 by using data from one or more of detectors 204-210 located externally to retail facility, internal data captured by one or more detectors in set of detectors 212 located internally to retail facility 202, such as identification data received from identification tags 230 and/or identification data received from identification tag 224.

The software in the data processing system keeps a list of which items have been placed in each shopping container, such as container 220. The list is stored in a database, such as, without limitation, a spreadsheet, relational database, hierarchical database or the like. The database may be stored in the operating memory of the data processing system, externally on a secondary data storage device, locally on a recordable medium such as a hard drive, floppy drive, CD ROM, DVD device, remotely on a storage area network, such as storage area network 108 in FIG. 1, or in any other type of storage device.

The lists of items in container 220 are updated frequently enough to maintain a dynamic, accurate, real time listing of the contents of each container as customers add and remove items from containers, such as container 220. The listings of items in containers are also made available to whatever inventory system is used in retail facility 202. Such listings represent an up-to-the-minute view of which items are still available for sale, for example, to on-line shopping customers or customers physically located at retail facility 202. The listings may also provide a demand side trigger back to the supplier of each item. In other words, the listing of items in customer shopping containers can be used to update inventories, determine current stock available for sale to customers, and/or identification of items that need to be restocked or replenished.

At any time, the customer using container 220 may request to see a listing of the contents of container 220 by entering a query at a user interface to the data processing system. The user interface may be available at a kiosk, computer, personal digital assistant, or other computing device connected to the data processing system via a network connection. The user interface may also be coupled to a display device, such as, at a display device in display devices 214, display devices 216, or display device 226 associated with container 220. The customer may also make such a query after leaving the retail store. For example, a query may be made using a portable device or a home computer workstation.

The listing is then displayed at a location where it may be viewed by the customer on a display device. The listing may include the quantity of each item in container 220, as well as the brand, price of each item, discount or amount saved off the regular price of each item, and a total price for all items in container 220. Other data may also be displayed as part of the listing, such as, additional incentives to purchase one or more other items.

When the customer is finished shopping, the customer may proceed to a point-of-sale checkout station. The checkout station may be coupled to the data processing system, in which case, the items in container 220 are already known to the data processing system due to the dynamic listing of items in container 220 that is maintained as the customer shops in digital customer marketing environment 200. Thus, there is no need for an employee, customer, or other person to scan each item in container 220 to complete the purchase of each item, as is commonly done today. In this example, the customer merely arranges for payment of the total, for example by use of a smart card, credit card, debit card, cash, or other payment method. In some embodiments, it may not be necessary to empty container 220 at the retail facility at all if container 220 is a minimal cost item which can be kept by the customer.

In other embodiments, container 220 belongs to the customer. The customer brings container 220 to retail facility 202 at the start of the shopping session. In another embodiment, container 220 belongs to retail facility 202 and must be returned before the customer leaves digital customer marketing environment 200.

In another example, when the customer is finished shopping, the customer may complete checkout either in-aisle or from a final or terminal-based checkout position in the store using a transactional device which may be integral with container 220 or associated temporarily to container 220. The customer may also complete the transaction using a consumer owned computing device, such as a laptop, cellular telephone, or personal digital assistant that is connected to the data processing system via a network connection.

The customer may also make payment by swiping a magnetic strip on a card, using any known or available radio frequency identification (RFID) enabled payment device, or using a biometric device for identifying the customer by the customer's fingerprint, voiceprint, thumbprint, and/or retinal pattern. In such as case, the customer's account is automatically charged after the customer is identified.

The transactional device may also be a portable device such as a laptop computer, palm device, or any other portable device specially configured for such in-aisle checkout service, whether integral with container 220 or separately operable. In this example, the transactional device connects to the data processing system via a network connection to complete the purchase transaction at check out time.

Checkout may be performed in-aisle or at the end of the shopping trip whether from any point or from a specified point of transaction. As noted above, checkout transactional devices may be stationary shared devices or portable or mobile devices offered to the customer from the store or may be devices brought to the store by the customer, which are compatible with the data processing system and software residing on the data processing system.

Thus, in this depicted example, when a customer enters digital customer marketing environment but before the customer enters retail facility 202, such as a retail store, the customer is detected and identified by one or more detectors in detectors 204-210 to generate external data. The customer identification may be an exact identification of the customer by name, identification by an identifier, or an anonymous identification that is used to track the customer even though the customer's exact name and identity is not known. If the customer takes a shopping container before entering retail facility 202, the shopping container is also identified. In some embodiments, the customer may be identified through identification of container 220.

An analysis server in a data processing system associated with retail facility 202 begins performing data mining on available static customer data, such as, but not limited to, customer profile information and demographic information, for use in generating customized marketing messages targeted to the customer. In one embodiment, the customer is presented with customized digital marketing messages on one or more display devices in display devices 216 located externally to retail facility 202 before the customer enters retail facility 202.

The customer is tracked using image data and/or other detection data captured by detectors 204-210 as the customer enters retail facility 202. The customer is identified and tracked inside retail facility 202 by one or more detectors inside the facility, such as set of detectors 212.

When the customer enters retail facility 202, the customer is typically offered, provided, or permitted to take shopping container 220 for use during shopping.

When the customer takes a shopping container, such as container 220, the analysis server uses data from set of detectors 212, such as, identification data from identification tags 230 and 224, to track container 220 and items selected by the customer and placed in container 220.

As a result, an item selected by the customer, for example, as the customer removes the item from its stationary position on a store display, is identified. The selected item may be traced visually by a camera, tracked by another type of detector in set of detectors 212 and/or using identification data from identification tags 230. The item is tracked until the customer places it in container 220 to form a selected item.

Thus, a selected item is identified when a customer removes an item from a store display, such as a shelf, display counter, basket, or hanger. In another embodiment, the selected item is identified when the customer places the item in the customer's shopping basket, shopping bag, or shopping cart. The analysis server then selects one or more upsale items related to the selected items for marketing to the customer. In another embodiment, the analysis server selects one or more cross-sale items correlated to the selected item. The analysis server stores a listing of selected items placed in the shopping container.

Container 220 may contain a digital media display, such as display device 226, mounted on container 220 and/or customer may be offered a handheld digital media display device, such as a display device in display devices 214. In the alternative, the customer may be encouraged to use strategically placed kiosks running digital media marketing messages throughout retail facility 202. Display device 226, 214, and/or 216 may include a verification device for verifying an identity of the customer.

For example, display device 214 may include a radio frequency identification tag reader 232 for reading a radio frequency identification tag, a smart card reader for reading a smart card, or a card reader for reading a specialized store loyalty or frequent customer card. Once the customer has been verified, the data processing system retrieves past purchase history, total potential wallet-share, shopper segmentation information, customer profile data, granular demographic data for the customer, and/or any other available customer data elements using known or available data retrieval and/or data mining techniques. These customer data elements are analyzed using at least one data model to determine appropriate digital media content to be pushed, on-demand, throughout the store to customers viewing display devices 214, 216, and/or display device 226.

The customer is provided with incentives to use display devices 214, 216, and/or display device 226 to obtain marketing incentives, promotional offers, and discounts for upsale items and/or cross-sale items correlated to one or more selected items. When the customer has finished shopping, the customer may be provided with a list of savings or “tiered” accounting of savings over the regular price of purchased items if a display device had not been used to view and use customized digital marketing messages.

In this example, a single container and a single customer is described. However, the aspects of the illustrative embodiments may also be used to track multiple containers and multiple customers simultaneously. In this case, the analysis server will store a separate listing of selected items for each active customer. As noted above, the listings may be stored in a database. The listing of items in a given container is displayed to a customer, employee, agent, or other customer in response to a query. The listing may be displayed to a customer at any time, either while actively shopping, during check-out, or after the customer leaves retail facility 202.

This process provides an intelligent guided selling methodology to optimize customer throughput in the store, thereby maximizing or optimizing total retail content and/or retail sales, profit, and/or revenue for retail facility 202. It will be appreciated by one skilled in the art that the words “optimize”, “optimization” and related terms are terms of art that refer to improvements in speed and/or efficiency of a computer program, and do not purport to indicate that a computer program has achieved, or is capable of achieving, an “optimal” or perfectly speedy/perfectly efficient state.

Next, FIG. 3 is a block diagram of a data processing system in which illustrative embodiments may be implemented. Data processing system 300 is an example of a computer, such as server 104 or client 110 in FIG. 1, in which computer usable code or instructions implementing the processes may be located for the illustrative embodiments. In this example, data is transmitted from data processing system 300 to the retail facility over a network, such as network 102 in FIG. 1. In another embodiment, data processing system 300 is located on-site at the retail facility.

In the depicted example, data processing system 300 employs a hub architecture including a north bridge and memory controller hub (MCH) 302 and a south bridge and input/output (I/O) controller hub (ICH) 304. Processing unit 306, main memory 308, and graphics processor 310 are coupled to north bridge and memory controller hub 302. Processing unit 306 may contain one or more processors and even may be implemented using one or more heterogeneous processor systems. Graphics processor 310 may be coupled to the MCH through an accelerated graphics port (AGP), for example.

In the depicted example, local area network (LAN) adapter 312 is coupled to south bridge and I/O controller hub 304 and audio adapter 316, keyboard and mouse adapter 320, modem 322, read only memory (ROM) 324, universal serial bus (USB) ports and other communications ports 332, and PCI/PCIe devices 334 are coupled to south bridge and I/O controller hub 304 through bus 338, and hard disk drive (HDD) 326 and CD-ROM drive 330 are coupled to south bridge and I/O controller hub 304 through bus 340. PCI/PCIe devices may include, for example, Ethernet adapters, add-in cards, and PC cards for notebook computers. PCI uses a card bus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be coupled to south bridge and I/O controller hub 304.

An operating system runs on processing unit 306 and coordinates and provides control of various components within data processing system 300 in FIG. 3. The operating system may be a commercially available operating system such as Microsoft Windows XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 300. Java and all Java-based trademarks are trademarks of Sun Microsystems, Inc. in the United States, other countries, or both.

Instructions for the operating system, the object-oriented programming system, and applications or programs are located on storage devices, such as hard disk drive 326, and may be loaded into main memory 308 for execution by processing unit 306. The processes of the illustrative embodiments may be performed by processing unit 306 using computer implemented instructions, which may be located in a memory such as, for example, main memory 308, read only memory 324, or in one or more peripheral devices.

In some illustrative examples, data processing system 300 may be a personal digital assistant (PDA), which is generally configured with flash memory to provide non-volatile memory for storing operating system files and/or customer-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 308 or a cache such as found in north bridge and memory controller hub 302. A processing unit may include one or more processors or CPUs.

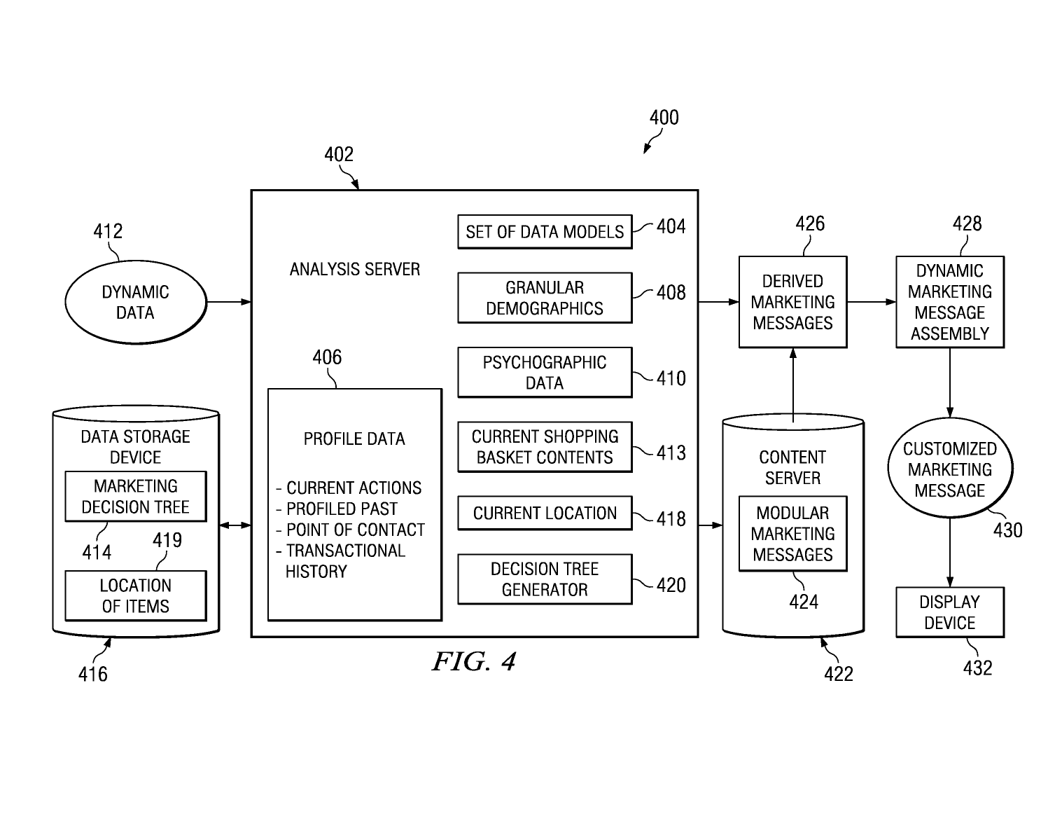

Referring now to FIG. 4, a block diagram of a data processing system for analyzing dynamic data to generate customized marketing messages is shown in accordance with an illustrative embodiment. Data processing system 400 is a data processing system, such as data processing system 100 in FIG. 1 and/or data processing system 300 in FIG. 3.

Analysis server 402 is any type of known or available server for analyzing dynamic customer data elements for use in generating customized digital marketing messages. Analysis server 402 may be a server, such as server 104 in FIG. 1 or data processing system 300 in FIG. 3. Analysis server 402 includes set of data models 404 for analyzing dynamic customer data elements and static customer data elements.

Set of data models 404 is one or more data models created a priori or pre-generated for use in analyzing customer data objects for personalizing content of marketing messages presented to the customer. Set of data models 404 includes one or more data models for identifying customer data objects and determining relationships between the customer data objects. The data models in set of data models 404 are generated using at least one of a statistical method, a data mining method, a causal model, a mathematical model, a marketing model, a behavioral model, a psychological model, a sociological model, or a simulation model.

Profile data 406 is data regarding one or more customers. In this example, profile data 406 includes point of contact data, profiled past data, current actions data, transactional history data, certain click-stream data, granular demographics 408, psychographic data 410, registration e.g. customer provided data, and account data and/or any other data regarding a customer.

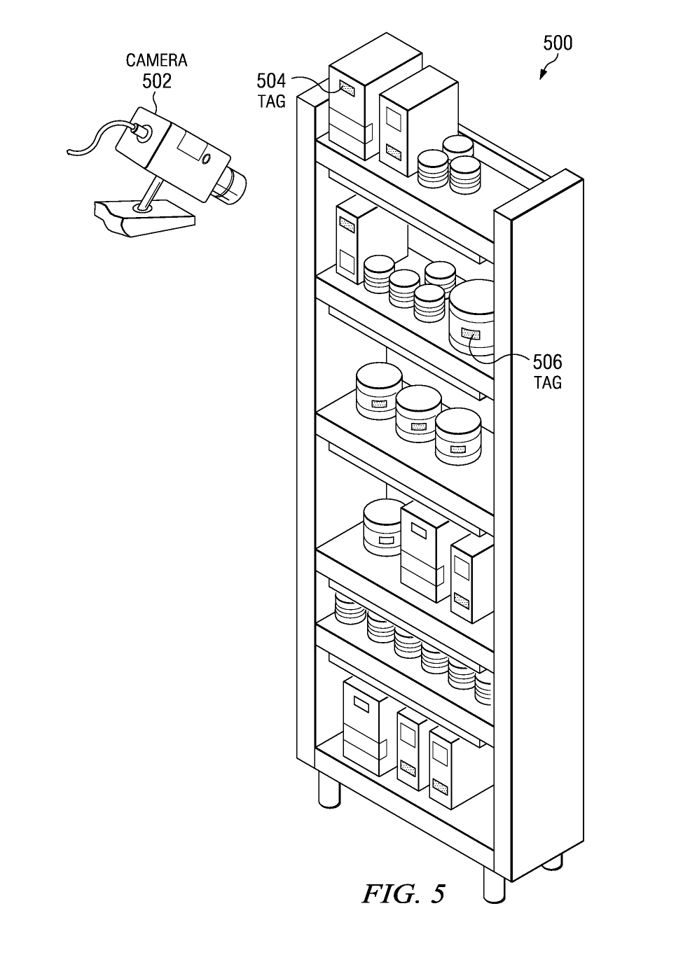

Point of contact data is data regarding a method or device used by a customer to interact with a data processing system of a merchant or supplier and/or receive customized marketing message 430 for display. The customer may interact with the merchant or supplier using a computing device or display terminal having a user interface for inputting data and/or receiving output. The device or terminal may be a device provided by the retail facility and/or a device belonging to or provided by the customer. For example, the display or access device may include, but is not limited to, a cellular telephone, a laptop computer, a desktop computer, a computer terminal kiosk, personal digital assistant (PDA) such as a personal digital assistant 400 in FIG. 4 or personal digital assistant 500 in FIG. 5 or any other display or access device, such as display device 432.

If display device 432 is a display device associated with the retail facility, details and information regarding display device 432 will be known to analysis server 402. However, if display device 432 is a display device belonging to the customer or brought to the retail facility by the customer, analysis server 402 may identify the type of display device using techniques such as interrogation commands, cookies, or any other known or equivalent technique. From the type of device other constraints may be determined such as display size, resolution, refresh rate, color capability, keyboard entry capability, other entry capability such as pointer or mouse, speech recognition and response, language constraints, and any other fingertip touch point constraints and assumptions about customer state of the display device. For example, someone using a cellular phone may have a limited time window for making phone calls and be sensitive to location and local time of day, whereas a casual home browser may have a greater luxury of time and faster connectivity.

An indication of a location for the point of contact may also be determined. For example, global positioning system (GPS) coordinates of the customer may be determined if the customer device has such a capability whether by including a real time global positioning system receiver or by periodically storing global positioning system coordinates entered by some other method. Other location indications may also be determined such as post office address, street or crossroad coordinates, latitude-longitude coordinates or any other location indicating system.

Analysis server 402 may also determine the connectivity associated with the customer's point of contact. For example, the customer may be connected to the merchant or supplier in any of a number ways such as a modem, digital modem, network, wireless network, Ethernet, intranet, or high speed lines including fiber optic lines. Each way of connection imposes constraints of speed, latency, and/or mobility which can then also be determined.

The profiled past comprises data that may be used, in whole or in part, for individualization of customized marketing message 430. Global profile data may be retrieved from a file, database, data warehouse, or any other data storage device. Multiple storage devices and software may also be used to store profile data 406. Some or all of the data may be retrieved from the point of contact device, as well. The profiled past may comprise an imposed profile, global profile, individual profile, and demographic profile. The profiles may be combined or layered to define the customer for specific promotions and marketing offers.

In the illustrative embodiments, a global profile includes data on the customer's interests, preferences, and affiliations. The profiled past may also comprise retrieving purchased data. Various firms provide data for purchase which is grouped or keyed to presenting a lifestyle or life stage view of customers by block or group or some other baseline parameter. The purchased data presents a view of one or more customers based on aggregation of data points such as, but not limited to geographic block, age of head of household, income level, number of children, education level, ethnicity, and purchasing patterns.

The profiled past may also include navigational data relating to the path the customer used to arrive at a web page which indicates where the customer came from or the path the customer followed to link to the merchant or supplier's web page. Transactional data of actions taken is data regarding a transaction. For example, transaction data may include data regarding whether the transaction is a first time transaction or a repeat transaction, and/or how much the customer usually spends. Information on how much a customer generally spends during a given transaction may be referred to as basket share. Data voluntarily submitted by the customer in responding to questions or a survey may also be included in the profiled past.

Current actions, also called a current and historical record, are also included in profile data 406. Current actions are data defining customer behavior. One source of current actions is listings of the purchases made by the customer, payments and returns made by the customer, and/or click-stream data from a point of contact device of the customer. Click-stream data is data regarding a customer's navigation of an online web page of the merchant or supplier. Click-stream data may include page hits, sequence of hits, duration of page views, response to advertisements, transactions made, and conversion rates. Conversion rate is the number of times the customer takes action divided by the number of times an opportunity is presented.

In this example, profiled past data for a given customer is stored in analysis server 402. However, in accordance with the illustrative embodiments, profiled past data may also be stored in any local or remote data storage device, including, but not limited to, a device such as storage area network 108 in FIG. 1 or read only memory (ROM) 324 and/or compact disk read only memory (CD-ROM) 330 in FIG. 3.

Granular demographics 408 is a source of static customer data elements. Static customer data elements are data elements that do not tend to change in real time, such as a customer's name, date of birth, and address. Granular demographics 408 provides a detailed demographics profile for one or more customers. Granular demographics 408 may include, without limitation, ethnicity, block group, lifestyle, life stage, income, and education data. Granular demographics 408 may be used as an additional layer of profile data 406 associated with a customer.

Psychographic data 410 refers to an attitude profile of the customer. Examples of attitude profiles include, without limitation, a trend buyer, a time-strapped person who prefers to purchase a complete outfit, a cost-conscious shopper, a customer that prefers to buy in bulk, or a professional buyer who prefers to mix and match individual items from various suppliers.

Dynamic data 412 is data that includes dynamic customer data elements that are changing in real-time. For example, dynamic customer data elements could include, without limitation, the current contents of a customer's shopping basket, the time of day, the day of the week, whether it is the customer's birthday or other holiday observed by the customer, customer's responses to marketing messages and/or items viewed by the customer, customer location, the customer's current shopping companions, the speed or pace at which the customer is walking through the retail facility, and/or any other dynamically changing customer information. Dynamic data 412 includes external data, grouping data, customer identification data, customer behavior data, and/or current events data.

Current events data is data describing an event, holiday, program, game, or news item of interest to the customer. For example, if the customer is a sports fan, current events data may include information regarding sporting events, such as football games. Customer identification data is data identifying the customer and/or the customer's vehicle. Grouping data is data describing the type of group that is associated with the customer, such as parents with children, unsupervised teenagers, senior citizens, a pet owner with a pet, or any other type of group.

Dynamic data 412 is processed and/or analyzed to generate customized marketing messages and/or for utilization in selecting items to be marketed to the customer. Processing dynamic data 412 includes, but is not limited to, filtering dynamic data 412 for relevant data elements, combining dynamic data 412 with other dynamic customer data elements, comparing dynamic data 412 to baseline or comparison models for external data, and/or formatting dynamic data 412 for utilization and/or analysis in one or more data models in set of data models 404. The processed dynamic data 412 is analyzed and/or further processed using one or more data models in set of data models 404.

Current shopping basket contents 413 is a list of the current contents of the customer's shopping container, such as container 220 in FIG. 2. The contents of the shopping container are tracked using at least one of camera images of items selected by the customer for purchase, camera images of the shopping container, data from identification tags, and/or data from any other detector.

Marketing decision tree 414 is a decision tree that includes a set of paths through the retail facility that the customer will most likely follow while shopping. The set of paths is a set of one or more possible paths. A path is a route through the retail facility. Marketing decision tree 414 indicates a ranking for each possible path. For example, if marketing decision tree 414 includes three possible paths through the retail facility at the point where the customer enters the retail facility, marketing decision tree 414 indicates which path is most likely, which path is the second most likely, and which path in the three possible paths is the least likely. In other words, when the customer enters the retail facility, the customer can go right, left, or down the center. Marketing decision tree 414 indicates that the most likely path is for the customer to go to the right toward the produce section, based on the paths through the retail store taken by the customer on previous visits to the retail facility. However, if the customer goes to the left, marketing decision tree 414 then indicates a next most likely path based on the customer going to the left. For example, marketing decision tree 414 may indicate that the customer is now most likely to go to the bakery based on the fact that the customer has gone to the left and based on previous routes through the retail facility taken by the customer on past visits.

Marketing decision tree 414 is stored on data storage device 416. Data storage device 416 is any type of data storage, such as, but not limited to, a hard disk, a flash memory, a compact disc (CD), a floppy disk, a remote data storage device, or any other type of data storage.

Current location 418 is a current location of the customer. The current location of the customer is determined based on at least one of images from a set of cameras, data from an identification tag associated with the customer's shopping container, data from identification tags associated with items in the shopping container, motion detector data, audio data from a microphone, data from a set of pressure sensors, data from a heat sensor, or data from one or more other detectors associated with the retail facility.

Location of items 419 is a map of the retail facility that includes the location of items in the retail facility. Thus, if marketing decision tree 414 indicates that the customer is most likely to follow a path through the retail facility to the bakery section to select bread rolls, analysis server 402 can identify the exact location of the bread rolls using location of items 419.

Decision tree generator 420 is a software component for generating marketing decision tree 414. Decision tree generator 420 generates marketing decision tree 414 using information from profile data 406, such as, but not limited to, a customer behavior profile for the customer that includes metadata describing behavior of the customer while shopping during past visits to the retail facility.

In one example, decision tree generator 420 retrieves a customer behavior profile for the customer from profile data 406. The customer behavior profile indicates customer behavior while shopping in past transactions, such as, without limitation, an average speed of walking through the retail facility, a typical time of day for shopping, a typical day of the week for shopping, a frequency of visits to the retail facility over a given time period, an average amount of time spent selecting each item that is purchased, an average number of items purchased during each transaction, and an average number of shopping companions accompanying the customer. Decision tree generator 420 analyzes the customer behavior profile to generate marketing decision tree 414.

In another example, decision tree generator 420 retrieves a customer behavior profile for the customer that includes grouping data for the customer while shopping in past transactions at the retail facility. The grouping data is dynamic data that identifies a grouping category for the customer. The grouping category describes the current companions of the customer while the customer is shopping. The grouping category includes, but is not limited to, parents with children, teenagers, children, minors unaccompanied by adults, minors accompanied by adults, grandparents with grandchildren, senior citizens, couples, friends, coworkers, a customer shopping with a pet, and a customer shopping alone. Decision tree generator 420 identifies a current grouping category for the customer based on current companions of the customer. Decision tree generator 420 analyzes the customer behavior profile and current grouping category to generate marketing decision tree 414. Marketing decision tree 414 comprises a path through the retail facility that the customer typically follows while shopping with the current grouping category.

When the customer concludes a current transaction at the retail facility to form a most recent transaction, decision tree generator 420 uses information regarding the path through the retail facility taken by the customer during the most recent transaction to update marketing decision tree 414.

Content server 422 is any type of known or available server for storing modular marketing messages 424. Content server 422 may be a server, such as server 104 in FIG. 1 or data processing system 300 in FIG. 3.

Modular marketing messages 424 are two or more self contained marketing messages that may be combined with one or more other modular marketing messages in modular marketing messages 424 to form a customized marketing message for display to the customer. Modular marketing messages 424 can be quickly and dynamically assembled and disseminated to the customer in real-time.

In this illustrative example, modular marketing messages 424 are pre-generated. In other words, modular marketing messages 424 are preexisting marketing message units that are created prior to analyzing dynamic data 412 associated with a customer using one or more data models to generate a personalized marketing message for the customer. Two or more modular marketing messages are combined to dynamically generate customized marketing message 430, customized or personalized for a particular customer. Although modular marketing messages 424 are pre-generated, modular marketing messages 424 may also include templates imbedded within modular marketing messages for adding personalized information, such as a customer's name or address, to the customized marketing message.

Derived marketing messages 426 is a software component for determining which modular marketing messages in modular marketing messages 424 should be combined or utilized to dynamically generate customized marketing message 430 for the customer in real time. Derived marketing messages 426 uses the output generated by analysis server 402 as a result of analyzing dynamic data 412 associated with a customer using one or more appropriate data models in set of data models 404 to identify one or more modular marketing messages for the customer. The output generated by analysis server 402 from analyzing dynamic data 412 using appropriate data models in set of data models 404 includes marketing message criteria for the customer.

In other words, dynamic data 412 is analyzed to generate personal marketing message criteria. Derived marketing messages 426 uses the marketing message criteria for the customer to select one or more modular marketing messages in modular marketing messages 424.

A customized marketing message is generated using personalized marketing message criteria that are identified using the dynamic data. Personalized marketing message criteria are criterion or indicators for selecting one or more modular marketing messages for inclusion in the customized marketing message. The personalized marketing message criteria may include one or more criterion. The personalized marketing message criteria may be generated, in part, a priori or pre-generated and in part dynamically in real-time based on the dynamic data for the customer and/or any available static customer data associated with the customer. Dynamic data 412 includes external data gathered outside the retail facility and/or dynamic data gathered inside the retail facility.

If an analysis of dynamic data 412 indicates that the customer is shopping with a large dog, the personal marketing message criteria may include criteria to indicate marketing of pet food and items for large dogs. Because people with large dogs often have large yards, the personal marketing message criteria may also indicate that yard items, such as yard fertilizer, weed killer, or insect repellant may should be marketed. The personal marketing message criteria may also indicate marketing elements designed to appeal to animal lovers and pet owners, such as incorporating images of puppies, images of dogs, phrases such as “man's best friend”, “puppy love”, advice on pet care and dog health, and/or other pet friendly images, phrases, and elements to appeal to the customer's tastes and interests.

Derived marketing messages 426 uses the output of one or more data models in set of data models 404 that were used to analyze dynamic data 412 associated with a customer to identify one or more modular marketing messages to be combined together to form the personalized marketing message for the customer.

For example, a first modular marketing message may be a special on a more expensive brand of peanut butter. A second modular marketing message may be a discount on jelly when peanut butter is purchased. In response to marketing message criteria that indicates the customer frequently purchases cheaper brands of peanut butter, the customer has children, and the customer is currently in an aisle of the retail facility that includes jars of peanut butter, derived marketing messages 426 will select the first marketing message and the second marketing message based on the marketing message criteria for the customer.

Dynamic marketing message assembly 428 is a software component for combining the one or more modular marketing messages selected by derived marketing messages 426 to form customized marketing message 430. Dynamic marketing message assembly 428 combines modular marketing messages selected by derived marketing messages 426 to create appropriate customized marketing message 430 for the customer. In the example above, after derived marketing messages 426 selects the first modular marketing message and the second modular marketing message based on the marketing message criteria, dynamic marketing message assembly 428 combines the first and second modular marketing messages to generate a customized marketing message offering the customer a discount on both the peanut butter and jelly if the customer purchases the more expensive brand of peanut butter. In this manner, dynamic marketing message assembly 428 provides assembly of customized marketing message 430 based on output from the data models analyzing dynamic data.

Customized marketing message 430 is a customized and unique, one-to-one customized marketing message for a specific customer. Customized marketing message 430 is generated using dynamic data 412 and/or static customer data elements, such as the customer's demographics and psychographics, to achieve this unique one-to-one marketing.

Customized marketing message 430 is generated for a particular customer based on dynamic customer data elements, such as grouping data, customer identification data, current events data, and customer behavior data. For example, if modular marketing messages 424 include marketing messages identified by numerals 1-20, customized marketing message 430 may be generated using marketing messages 2, 8, 9, and 19. In this example, modular marketing messages 2, 8, 9, and 19 are combined to create a customized marketing message that is generated for display to the customer rather than displaying the exact same marketing messages to all customers. Customized marketing message 430 is displayed on display device 432.

Customized marketing message 430 may include advertisements, sales, special offers, incentives, opportunities, promotional offers, rebate information and/or rebate offers, discounts, and opportunities. An opportunity may be a “take action” opportunity, such as asking the customer to make an immediate purchase, select a particular item, request a download, provide information, or take any other type of action.

Customized marketing message 430 may also include content or messages pushing advertisements and opportunities to effectively and appropriately drive the point of contact customer to some conclusion or reaction desired by the merchant.

Customized marketing message 430 is formed in a dynamic closed loop manner in which the content delivery depends on dynamic data 412, as well as other dynamic customer data elements and static customer data, such as profile data 406 and granular demographics 408. Therefore, all interchanges with the customer may sense and gather data associated with customer behavior, which is used to generate customized marketing message 430.

Display device 432 is a multimedia display for presenting customized marketing messages to one or more customers. Display device 432 may be a multimedia display, such as, but not limited to, display devices 214, 216, and 226 in FIG. 2. Display device 432 may be, for example, a personal digital assistant (PDA), a cellular telephone with a display screen, an electronic sign, a laptop computer, a tablet PC, a kiosk, a digital media display, a display screen mounted on a shopping container, and/or any other type of device for displaying digital messages to a customer.

Thus, a merchant has a capability for interacting with the customer on a direct one-to-one level by sending customized marketing message 430 to display device 432. Customized marketing message 430 may be sent and displayed to the customer via a network. For example, customized marketing message 430 may be sent via a web site accessed as a unique uniform resource location (URL) address on the World Wide Web, as well as any other networked connectivity or conventional interaction including, but not limited to, a telephone, computer terminal, cell phone or print media.

Display device 432 may be a display device mounted on a shopping cart, a shopping basket, a shelf or compartment in a retail facility, included in a handheld device carried by the customer, or mounted on a wall in the retail facility. In response to displaying customized marketing message 430, a customer can select to print the customized marketing message 430 as a coupon and/or as a paper or hard copy for later use. In another embodiment, display device 432 automatically prints customized marketing message 430 for the customer rather than displaying customized marketing message 430 on a display screen or in addition to displaying customized marketing message 430 on the display screen.

In another embodiment, display device 432 provides an option for a customer to save customized marketing message 430 in an electronic form for later use. For example, the customer may save customized marketing message 430 on a hand held display device, on a flash memory, a customer account in a data base associated with analysis server 402, or any other data storage device. In this example, when customized marketing message 430 is displayed to the customer, the customer is presented with a “use offer now” option and a “save offer for later use” option. If the customer chooses the “save offer” option, the customer may save an electronic copy of customized marketing message 430 and/or print a paper copy of customized marketing message 430 for later use.

FIG. 5 is a block diagram of a shelf in a retail facility in accordance with an illustrative embodiment. Shelf 500 is any type of device for showing, displaying, storing, or holding items. Shelf 500 may be a shelf in a refrigerator or a freezer, as well as a shelf at room temperature.

Camera 502 is an example of one or more cameras inside the retail facility for capturing data associated with a customer. Camera 502 captures a continuous stream of video data as customers browse shelf 500 and select items on shelf 500. When a customer is standing in proximity to shelf 500, such as when a customer is shopping, browsing, and/or selecting one or more items for purchase, camera 502 records images of the customer and the items selected by the customer.

The items on shelf 500 include identification tags 504 and 506. Identification tags 504 and 506 are tags for providing information describing an item associated with the identification tag to an identification tag reader. Identification tags 504 and 506 may be implemented as tags such as identification tags 230 and identification tag 224.

FIG. 6 is a block diagram of a shopping container in accordance with an illustrative embodiment. Shopping container 600 is a container for carrying, moving, or holding items selected by a customer, such as container 220 in FIG. 2. In this example, container 600 is a shopping cart.

Display device 602 is a multimedia display device for presenting or displaying customized digital marketing messages to one or more customers, such as display devices 216 and 226 in FIG. 2 and/or display device 430 in FIG. 4. In this example, display device is coupled to shopping container 600. Display device 602 displays customized digital marketing messages received from a derived marketing messages device, such as derived marketing messages 626 in FIG. 6.

Biometric device 604 is any type of known or available device for measuring a physiological response or trait associated with a customer. Biometric device 604 is a biometric device, such as, without limitation, biometric device 222 in FIG. 2. Biometric device 604 may be a biometric device for scanning a fingerprint, scanning a thumbprint, scanning a palm print, measuring a customer's heart rate over a given period of time, a change in voice stress for the customer's voice, a change in blood pressure, and/or a change in pupil dilation that does not correlate or correspond to a change in an ambient lighting level.

In this example, biometric device 604 is coupled to shopping container 600. Biometric device 604 monitors biometric readings of a customer and detects changes in the biometric readings of the customer that exceeds a threshold change. In this example, biometric device 604 is a device for scanning the customer's fingerprint.

In another embodiment, biometric device 604 may also identify a customer based on a voiceprint analysis, and/or retinal scan. For example, biometric device 604 may dynamically identify the customer by scanning the customer's fingerprint and/or analyzing fingerprint data associated with the customer to determine the customer's identity. In one example, biometric device 604 may, but is not required to be connected to a remote data storage device storing data to retrieve customer fingerprint data for use in identifying a given customer using the customer's fingerprint. Biometric device 604 may be connected to the remote data storage device via a wireless network connection, such as network 102 in FIG. 1.

In this example, biometric device 604 is coupled, attached, or imbedded in a handle of shopping container 600. However, biometric device 604 may be coupled, attached, or imbedded in or on any part or member of shopping container 600.

In another embodiment, biometric device 604 is coupled, attached, associated with, or imbedded within display device 602. In this example, display device 602 may use biometric device 604 to dynamically identifying the customer by scanning the customer's fingerprint and/or analyzing data associated with the customer's fingerprint to determine the customer's identity.

Tag reader 608 is a device for receiving data from an identification tag associated with an item, such as identification tag reader 232 in FIG. 2. Tag reader 608 is implemented as, without limitation, a radio frequency identification tag reader or a universal product code reader.

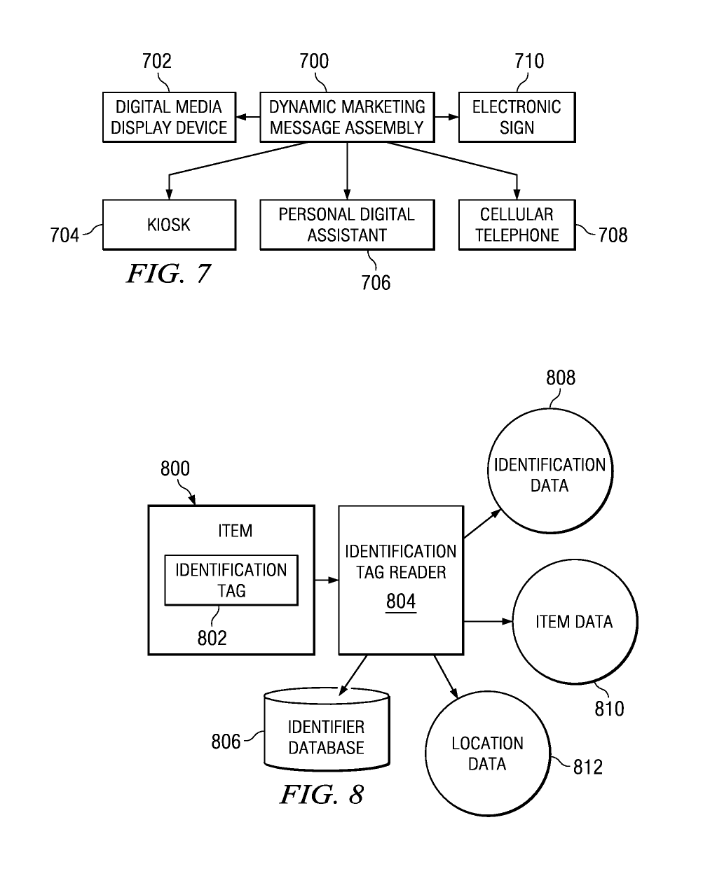

FIG. 7 is a block diagram of a dynamic marketing message assembly transmitting a customized marketing message to a set of display devices in accordance with an illustrative embodiment. Dynamic marketing message assembly 700 is a software component for combining two or more modular marketing messages into a customized marketing message for a customer. Dynamic marketing message assembly 700 may be a component such as dynamic marketing message assembly 628 in FIG. 6.

Dynamic marketing message assembly 700 transmits a customized marketing message, such as customized marketing message 430 in FIG. 4, to one or more display devices in a set of display devices. In this example, the set of display devices includes, but is not limited to, digital media display device 702, kiosk 704, personal digital assistant 706, cellular telephone 708, and/or electronic sign 710. A set of display devices in accordance with the illustrative embodiments may include any combination of display devices and any number of each type of display device. For example, a set of display devices may include, without limitation, six kiosks, fifty personal digital assistants, and no cellular telephones. In another example, the set of display devices may include electronic signs and kiosks but no personal digital assistants or cellular telephones.

Digital media display device 702 is any type of known or available digital media display device for displaying a marketing message. Digital media display device 702 may include, but is not limited to, a monitor, a plasma screen, a liquid crystal display screen, and/or any other type of digital media display device.

Kiosk 704 is any type of known or available kiosk. In one embodiment, a kiosk is a structure having one or more open sides, such as a booth. The kiosk includes a computing device associated with a display screen located inside or in association with the structure. The computing device may include a user interface for a user to provide input to the computing device and/or receive output. For example, the user interface may include, but is not limited to, a graphical user interface (GUI), a menu-driven interface, a command line interface, a touch screen, a voice recognition system, an alphanumeric keypad, and/or any other type of interface.

Personal digital assistant 706 is any type of known or available personal digital assistant (PDA). Cellular telephone 708 is any type of known or available cellular telephone and/or wireless mobile telephone. Cellular telephone 708 includes a display screen that is capable of displaying pictures, graphics, and/or text. Additionally, cellular telephone 708 may also include an alphanumeric keypad, joystick, and/or buttons for providing input to cellular telephone 708. The alphanumeric keypad, joystick, and/or buttons may be used to initiate various functions in cellular telephone 708. These functions include for example, activating a menu, displaying a calendar, receiving a call, initiating a call, displaying a customized marketing message, saving a customized marketing message, and/or selecting a saved customized marketing message.

Electronic sign 710 is any type of electronic messaging system. For example, electronic sign 710 may include, without limitation, an outdoor electronic light emitting diode (LED) display, moving message boards, variable message signs, tickers, electronic message centers, video boards, and/or any other type of electronic signage.

The display device may also include, without limitation, a laptop computer, a smart watch, a digital message board, a monitor, a tablet PC, a printer for printing the customized marketing message on a paper medium, or any other output device for presenting output to a customer.

A display device may be located externally to the retail facility to display marketing messages to the customer before the customer enters the retail facility. In another embodiment, the customized marketing message is displayed to the customer on a display device inside the retail facility after the customer enters the retail facility and begins shopping.

Turning now to FIG. 8, a block diagram of an identification tag reader for identifying items selected by a customer is shown in accordance with an illustrative embodiment. Item 800 is any type of item, such as retail items 228 in FIG. 2. Identification tag 802 associated with item 800 is a tag for providing information regarding item 800 to identification tag reader 804. Identification tag 802 is a tag such as a tag in identification tags 230 in FIG. 2. Identification tag 802 may be a bar code, a radio frequency identification tag, a global positioning system tag, and/or any other type of tag.

Radio Frequency Identification tags include read-only identification tags and read-write identification tags. A read-only identification tag is a tag that generates a signal in response to receiving an interrogate signal from an item identifier. A read-only identification tag does not have a memory. A read-write identification tag is a tag that responds to write signals by writing data to a memory within the identification tag. A read-write tag can respond to interrogate signals by sending a stream of data encoded on a radio frequency carrier. The stream of data can be large enough to carry multiple identification codes. In this example, identification tag 802 is a radio frequency identification tag.

Identification tag reader 804 is any type of known or available device for retrieving information from identification tag 802. Identification tag reader 804 may be, but is not limited to, a radio frequency identification tag reader or a bar code reader, such as identification tag reader 232 in FIG. 2. A bar code reader is a device for reading a bar code, such as a universal product code. In this example, identification tag reader 804 provides identification data 808, item data 810, and/or location data 812 to an analysis server, such as analysis server 402 in FIG. 4.

Identification data 808 is data regarding the product name and/or manufacturer name of item 800 selected for purchase by a customer. Item data 810 is information regarding item 800, such as, without limitation, the regular price, sale price, product weight, and/or tare weight for item 800. Identification data 808 is used to identify a selected item, such as selected item 420 in FIG. 4.

Location data 812 is data regarding a location of item 800 within the retail facility and/or outside the retail facility. For example, if identification tag 802 is a bar code, the item associated with identification tag 802 must be in close physical proximity to identification tag reader 804 for a bar code scanner to read a bar code on item 800. Therefore, location data 812 is data regarding the location of identification tag reader 804 currently reading identification tag 802. However, if identification tag 802 is a global positioning system tag, a substantially exact or precise location of item 800 may be obtained using global positioning system coordinates obtained from the global positioning system tag.

Identifier database 806 is a database for storing any information that may be needed by identification tag reader 804 to read identification tag 802. For example, if identification tag 802 is a radio frequency identification tag, identification tag will provide a machine readable identification code in response to a query from identification tag reader 804. In this case, identifier database 806 stores description pairs that associate the machine readable codes produced by identification tags with human readable descriptors. For example, a description pair for the machine readable identification code “10141014111111” associated with identification tag 802 would be paired with a human readable item description of item 800, such as “orange juice.” An item description is a human understandable description of an item. Human understandable descriptions are for example, text, audio, graphic, or other representations suited for display or audible output.

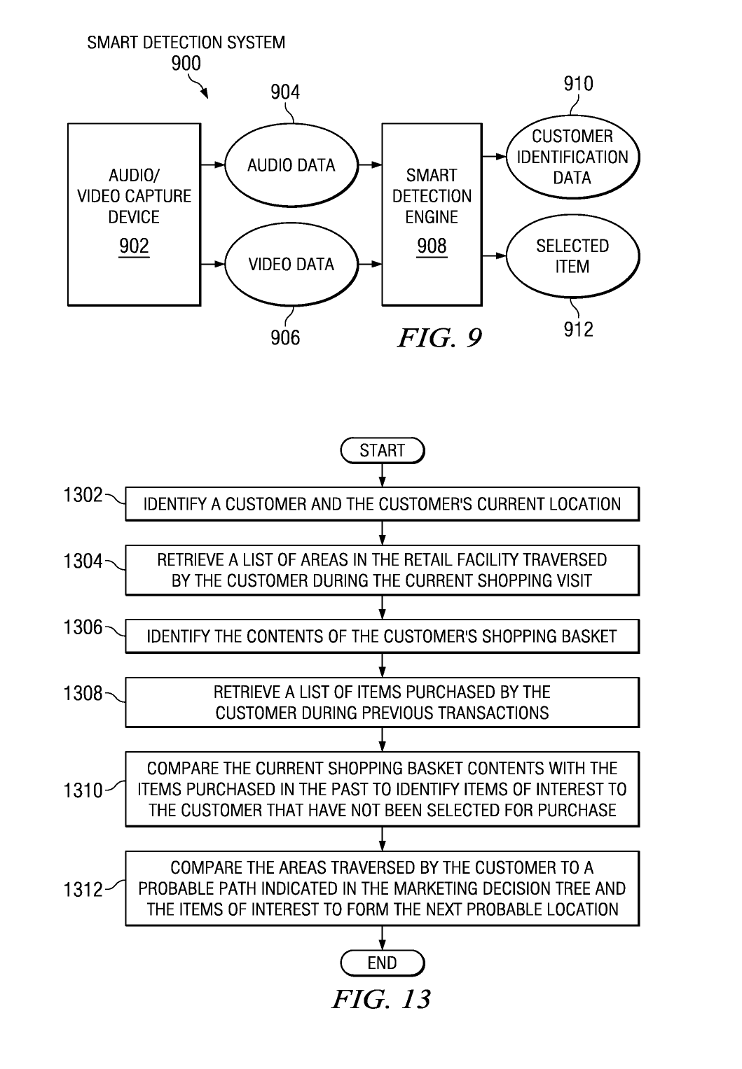

FIG. 9 is a block diagram illustrating a smart detection engine for generating customer identification data and selected item data in accordance with an illustrative embodiment. Smart detection system 900 is a software architecture for analyzing camera images and other detection data to form dynamic data, such as customer identification data 910, grouping data, and event data associated with the customer.

In this example, the detection data is video images captured by a camera. However, the detection data may also include, without limitation, pressure sensor data captured by a set of pressure sensors, heat sensor data captured by a set of heat sensors, motion sensor data captured by a set of motion sensors, audio captured by an audio detection device, such as a microphone, or any other type of detection data described herein.

Audio/video capture device 902 is a device for capturing video images and/or capturing audio. Audio/video capture device 902 may be, but is not limited to, a digital video camera, a microphone, a web camera, or any other device for capturing sound and/or video images.

Audio data 904 is data associated with audio captured by audio/video capture device 902, such as human voices, vehicle engine sounds, dog barking, horns, and any other sounds. Audio data 904 may be a sound file, a media file, or any other form of audio data. Audio/video capture device 902 captures audio associated with a set of one or more customers inside a retail facility and/or outside a retail facility to form audio data 904.

Audio data 904 is used to generate dynamic data, including, but not limited to, customer identification data. For example, audio data of the customer's vehicle engine is compared to sound files of a plurality of vehicle engines. The make and/or model of the vehicle can be identified by matching the customer's vehicle engine to a known vehicle engine sound. Once the customer's vehicle is identified, the customer can be identified using the vehicle identification data.

Video data 906 is image data captured by audio/video capture device 902. Video data 906 may be a moving video file, a media file, a still picture, a set of still pictures, or any other form of image data. Video data 906 is video or images associated with a set of one or more customers inside a retail facility and/or outside a retail facility.

For example, video data 906 may include images of a customer's face, an image of a part or portion of a customer's car, an image of a license plate on a customer's car, and/or one or more images showing a customer's behavior. An image showing a customer's behavior or appearance may show a customer wearing a long coat on a hot day, a customer walking with two small children which may be the customer's children or grandchildren, a customer moving in a hurried or leisurely manner, or any other type of behavior or appearance attributes of a customer, the customer's companions, or the customer's vehicle.

Audio/video capture device 902 transmits audio data 904 and video data 906 to smart detection engine 908. Audio data 904 and video data 906 may be referred to as detection data. Smart detection engine 908 is software for analyzing audio data 904 and video data 906. In this example, smart detection engine 908 processes audio data 904 and video data 906 into data and metadata to form dynamic data. The dynamic data includes, but not limited to, external data, customer identification data 910, grouping data, customer event data, and current events data 922. Customer grouping data is data describing a customer's companions, such as children, parents, siblings, peers, friends, and/or pets. In this example, smart detection engine 908 also analyzes audio data 904 and video data 906 to identify selected item 912. Selected item 912 may also be identified using identification tag data, such as, without limitation, radio frequency identification data.

Processing the audio data 904 and video data 906 may include filtering audio data 904 and video data 906 for relevant data elements, analyzing audio data 904 and video data 906 to form metadata describing or categorizing the contents of audio data 904 and video data 906, or combining audio data 904 and video data 906 with other audio data, video data, and data associated with a group of customers received from cameras.

Smart detection engine 908 uses computer vision and pattern recognition technologies to analyze audio data 904 and/or video data 906. Smart detection engine 908 includes license plate recognition technology which may be deployed in a parking lot or at the entrance to a retail facility where the license plate recognition technology catalogs a license plate of each of the arriving and departing vehicles in a parking lot associated with the retail facility.

Smart detection engine 908 includes behavior analysis technology to detect and track moving objects and classify the objects into a number of predefined categories. As used herein, an object may be a human customer, an item, a container, a shopping cart or shopping basket, or any other object inside or outside the retail facility. Behavior analysis technology could be deployed on various cameras overlooking a parking lot, a perimeter, or inside a facility.

Face detection/recognition technology may be deployed in parking lots, at entry ways, and/or throughout the retail facility to capture and recognize faces. Badge reader technology may be employed to read badges. Radar analytics technology may be employed to determine the presence of objects. Events from access control technologies can also be integrated into smart detection engine 908.

The events from all the above detection technologies are cross indexed into a single repository, such as multi-mode database. In such a repository, a simple time range query across the modalities will extract license plate information, vehicle appearance information, badge information, and face appearance information, thus permitting an analyst to easily correlate these attributes.

Smart detection system 900 may be implemented using any known or available software for performing voice analysis, facial recognition, license plate recognition, and sound analysis. In this example, smart detection system 900 is implemented as IBM® smart surveillance system (S3) software.

The data gathered from the behavior analysis technology, license plate recognition technology, face detection/recognition technology, badge reader technology, radar analytics technology, and any other video/audio data received from a camera or other video/audio capture device is received by smart detection engine 908 for processing into dynamic data.

The marketing decision tree indicates a set of paths through the retail facility that the customer will most likely follow while shopping. The set of paths is a set of one or more paths. In one embodiment, a path is a branching paths such that the path indicates a next probable location of the customer given the customer's current location and given the customer's next actual location. For example, the paths can indicate which area of the retail facility the customer is most likely to go to based on where the customer is now and which directions the customer is going. The path shows, for example, and without limitation, that a customer is most likely to go to the ice cream section if the customer turns right and the customer is most likely to go to the produce section to select apples or oranges if the customer turns left. If the customer instead goes down a center aisle without turning, the path branches to indicate the most likely area or location in the retail store the customer is going towards based on the fact that the customer did not turn right or left. Thus, the marketing decision tree dynamically branches based on the customer's movements to anticipate the most likely location, area, or section of an aisle that the customer wants to visit, view, or browse.

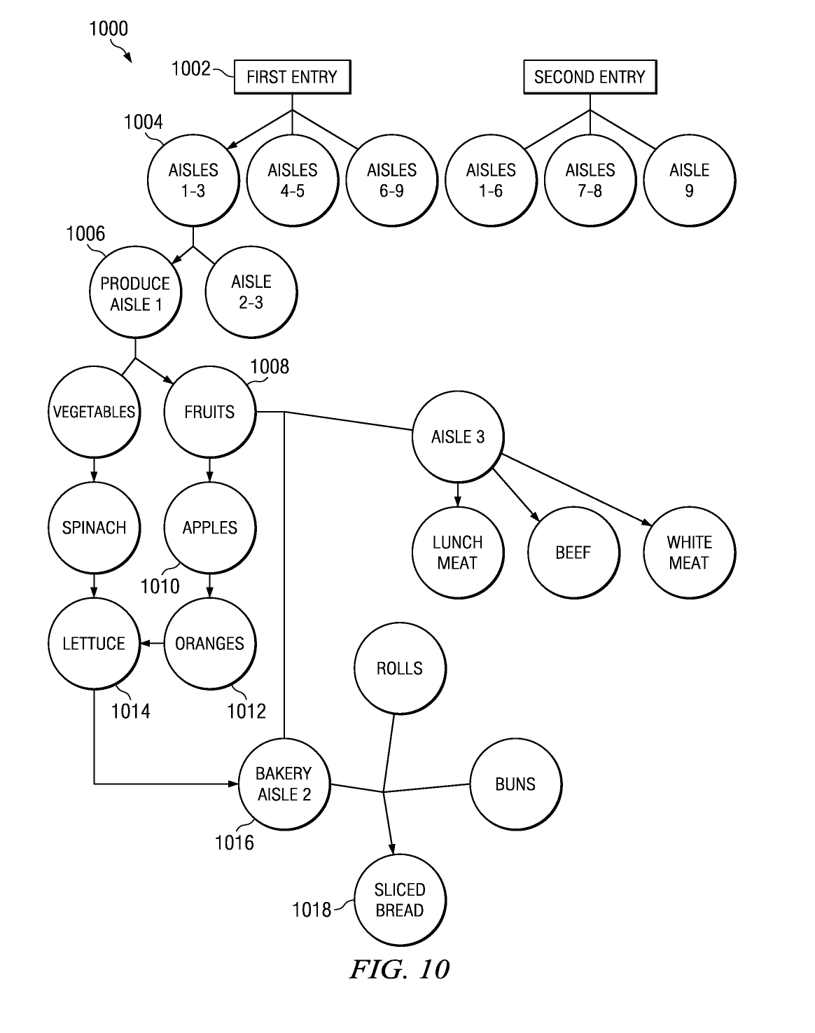

FIG. 10 is a block diagram illustrating a marketing decision tree in accordance with an illustrative embodiment. Marketing decision tree 1000 is a set of paths that the customer is likely to take through the retail facility. Marketing decision tree 1000 is generated using customer profile data, information describing previous paths the customer has taken through the retail facility on past visits and items purchased by the customer during previous transactions made on previous visits to the retail facility. Marketing decision tree 1000 indicates one or more paths that the customer is likely to take based on the current location of the customer.

For example, if the customer's current location is first entry 1002, marketing decision tree 1000 indicates the customer is most likely to follow a path to aisles 1-3 1004, to the produce section on aisle 1 1006. Once at the produce section, the customer is most likely to select fruits 1008, such as apples 1010 and oranges 1012. The customer is then likely to select lettuce 1014.

If the customer follows this path, marketing decision tree 1000 indicates the customer is most likely to go from the produce section to the bakery section on aisle 2 1016. If the customer follows this path, the customer is most likely to select sliced bread 1018.

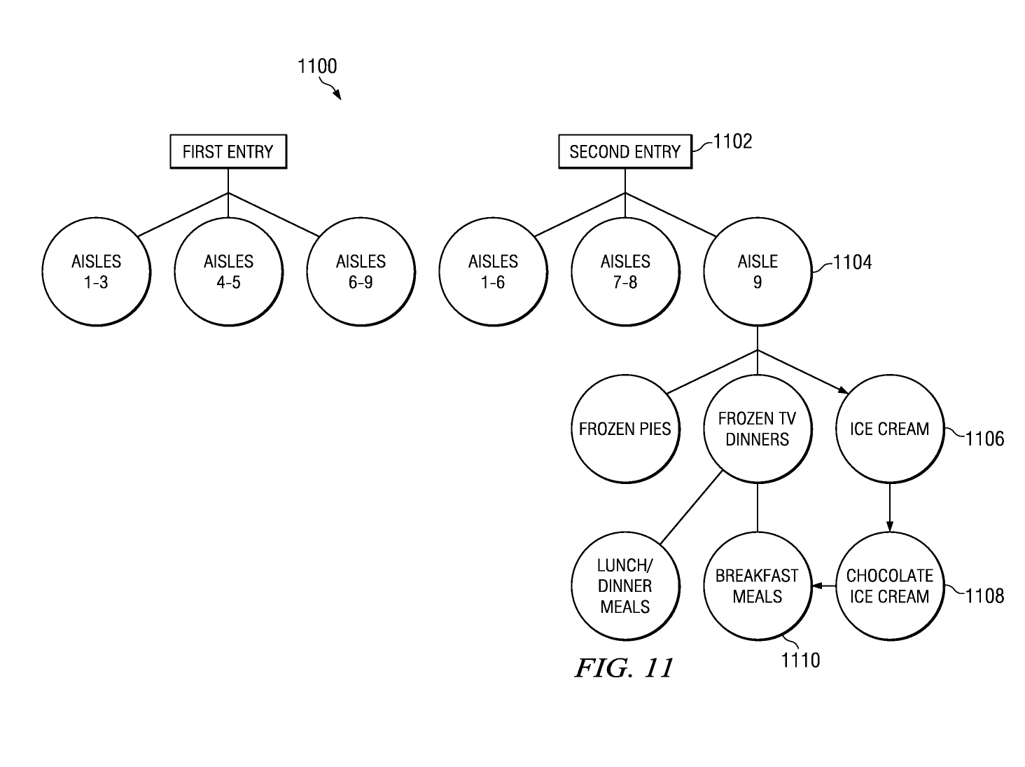

FIG. 11 is a block diagram illustrating a path in a marketing decision tree in accordance with an illustrative embodiment. Marketing decision tree 1100 is a marketing decision tree, such as marketing decision tree 1000 in FIG. 10. In the path shown in FIG. 10, the customer is predicted to enter the first entry. If the customer enters at second entry 1102 instead, marketing decision tree 1100 predicts that the customer is most likely to follow a path through the retail facility to the freezer section on aisle 9 1104. If the customer goes to aisle 9, marketing decision tree 1100 indicates the customer is most likely to go to ice cream section 1106. Once in the ice cream section, marketing decision tree 1100 indicates the customer is most likely to select chocolate flavored ice cream 1108. In this manner, the process can predict either a general type of item of interest to the customer, such as ice cream, and/or a specific size, flavor, or brand of item, such as chocolate ice cream.

Marketing decision tree 1100 then predicts the next probable location as the location of frozen breakfast meals and identifies the next most likely item as frozen breakfast meals 1110.

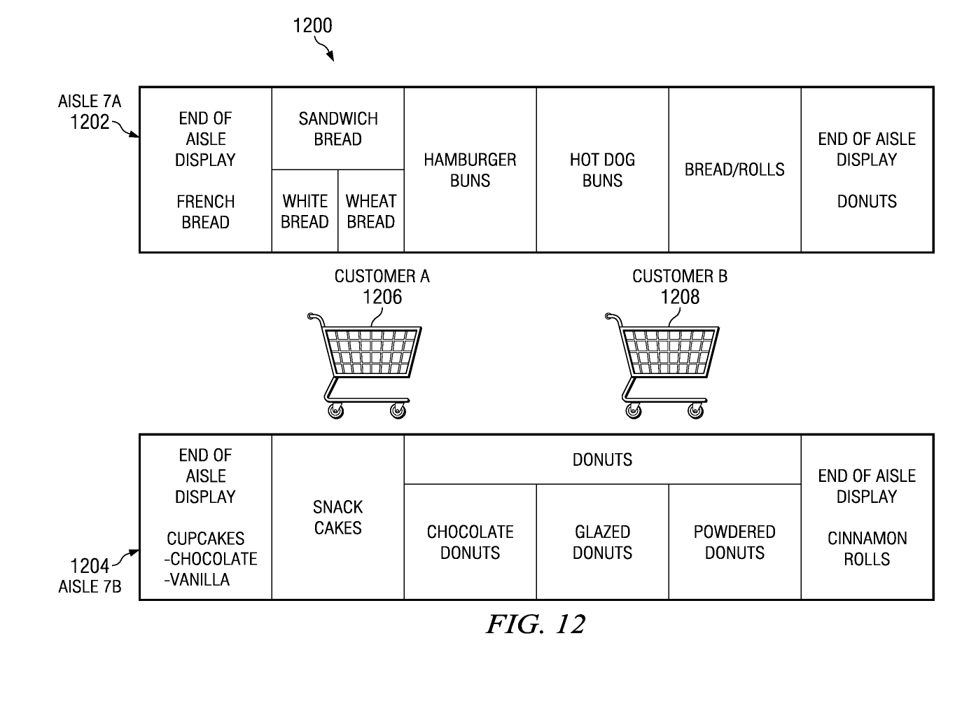

FIG. 12 is a block diagram of a representation of the retail facility showing the location of items in the retail facility in accordance with an illustrative embodiment. Representation 1200 is generated using images of customers and items in the retail facility and information regarding the locations of items, shelves, and displays in the retail facility. In this example, representation 1200 is a representation of aisle 7 in the retail facility. Representation 1200 shows an end of the aisle display with French bread 1202 on one side of the aisle and an end of the aisle display with cupcakes 1204 on the other side of the aisle. Representation 1200 also shows the location of customers, such as customer A 1206 and customer B 1208. In this manner, the process identifies the current location of the customer, a next probable location of the customer, and items of interest to the customer using marketing decision tree 1200.

FIG. 13 is a flowchart illustrating a process for using a marketing decision tree to identify a next location of the customer in accordance with an illustrative embodiment. The process is implemented by analysis server 402 in FIG. 4. The process begins by identifying a customer and the customer's current location (step 1302). The process retrieves a list of areas in the retail facility traversed by the customer during the current shopping visit (step 1304). Areas traversed by the customer are areas that the customer has already visited, browsed in, occupied, walked through, or otherwise covered during the current shopping visit to the retail facility.

The process identifies the contents of the customer's shopping basket (step 1306). The process retrieves a list of items purchased by the customer during previous transactions made on previous visits to the retail facility (step 1308). The process compares the current shopping basket contents with the items purchased in the past to identify items of interest to the customer that have not yet been selected by the customer for purchase (step 1310). An item of interest is an item that the customer is likely to purchase, such as, but not limited to, items that the customer has purchased in the past and/or items that are frequently purchased by the same type of customer. The process compares the areas traversed by the customer to a probable path indicated in the marketing decision tree and the items of interest to form the next probable location of the customer (step 1312) with the process terminating thereafter.

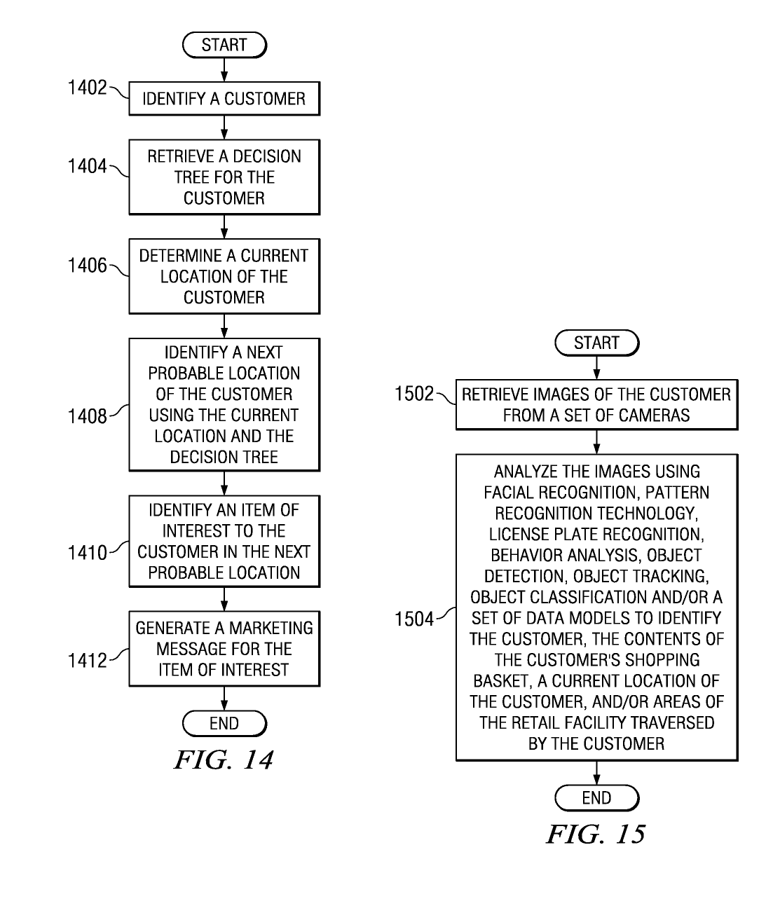

FIG. 14 is a flowchart illustrating a process for generating a marketing message using a marketing decision tree in accordance with an illustrative embodiment. The process is implemented by analysis server 402 in FIG. 4. The process begins by identifying a customer (step 1402). The process retrieves a decision tree for the customer (step 1404). The process determines a location of the customer (step 1406). The process identifies a next probable location of the customer using the current location and the marketing decision tree (step 1408). The process identifies an item of interest to the customer in the next probable location (step 1410). The process generates a marketing message for the item of interest (step 1412) with the process terminating thereafter.

FIG. 15 is a flowchart illustrating a process for generating a representation of the retail facility in accordance with an illustrative embodiment. The process is implemented by analysis server 402 in FIG. 4. The process begins by retrieving images of the customer from a set of cameras (step 1502). The process analyzes the images using facial recognition, pattern recognition technology, license plate recognition, behavior analysis, object detection, object tracking, object classification and/or a set of data models to identify the customer, the contents of the customer's shopping basket, a current location of the customer, and/or areas of the retail facility that have already been traversed by the customer (step 1504) with the process terminating thereafter.

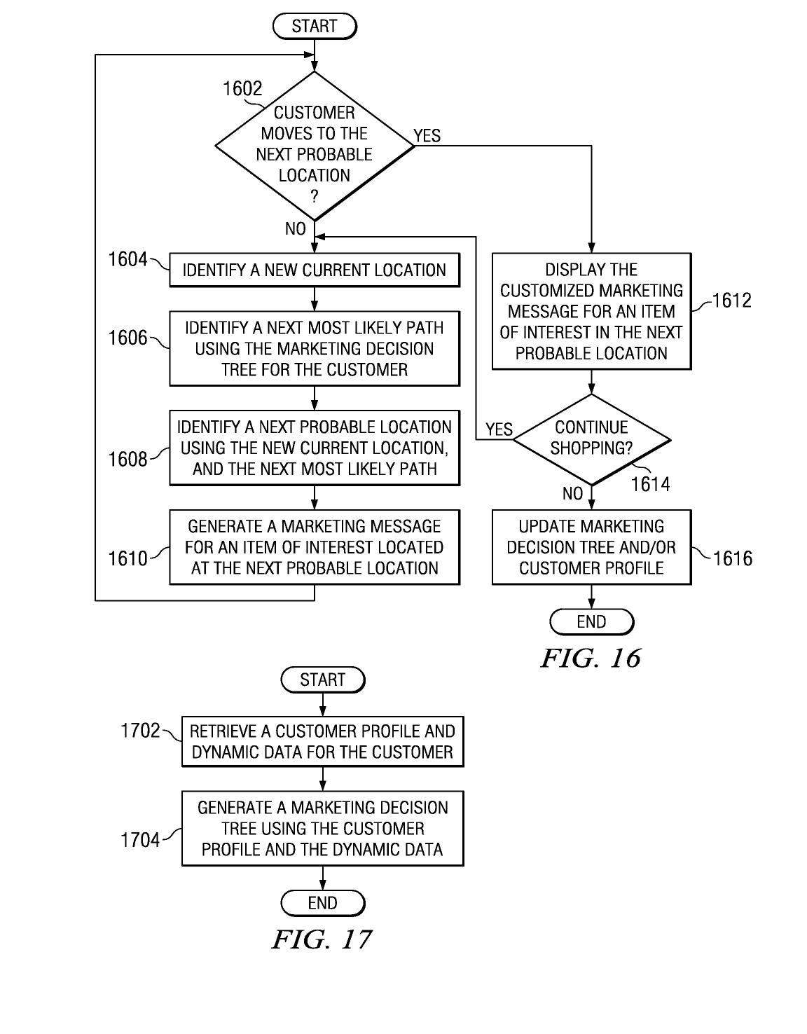

FIG. 16 is a flowchart illustrating a process for marketing to a customer using a marketing decision tree in accordance with an illustrative embodiment. The process is implemented by analysis server 402 in FIG. 4. The process begins by making a determination as to whether the customer moves to the next probable location that was predicted by the marketing decision tree (step 1602). If the customer does not move to the next probable location, the process identifies a new current location of the customer (step 1604) and identifies a next most likely path using the marketing decision tree for the customer (step 1606). The process identifies a next probable location using the new current location and the next most likely path (step 1608). In other words, if the marketing decision tree predicts the customer will go to the right, but instead, the customer goes to the left, the marketing decision tree will make a new prediction as to where the customer will go next based on the current location of the customer, that is, the location to the left.

Next, the process generates a marketing message for an item of interest located at the next probable location (step 1610). The process then determines whether the customer moves to the next probable location predicted (step 1602). If the customer does move to the predicted next probable location, the process displays the customized marketing message for the item of interest located in the next probable location, which is now the customer's current location (step 1612). The process makes a determination as to whether the customer is continuing to shop (step 1614). If the customer continues to shop, the process iteratively implements steps 1602-1614 until the customer ceases to shop. The shopping ceases when the customer completes the transaction by purchasing the items at a point of sale or other method for completing the transaction. The process then updates the marketing decision tree and/or customer profile with data describing the items purchased, data describing the customer's behavior, and the path taken through the retail facility during this most recent shopping trip (step 1616) with the process terminating thereafter.

FIG. 17 is a flowchart illustrating a process for generating a marketing decision tree in accordance with an illustrative embodiment. The process is implemented by decision tree generator 420 in FIG. 4. The process retrieves a customer profile and dynamic data for the customer (step 1702). The dynamic data includes current dynamic data, as well as dynamic data gathered during the customer's past transactions. The process generates the marketing decision tree using the customer profile data and the dynamic data (step 1704) with the process terminating thereafter.

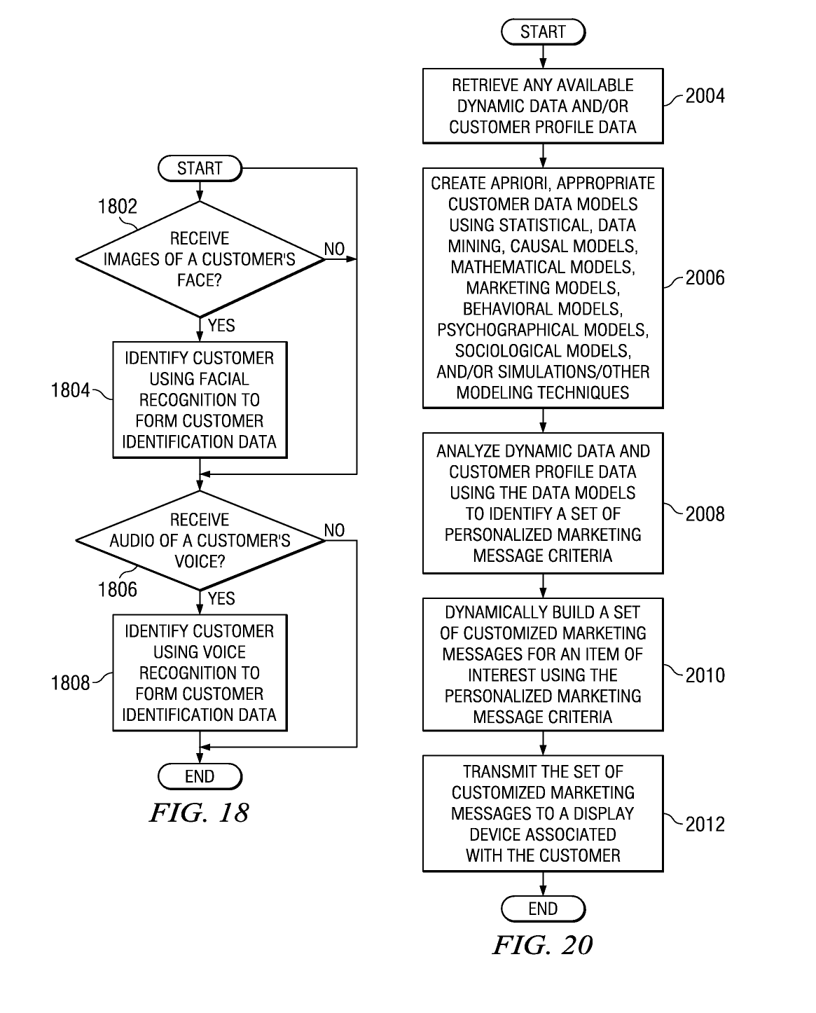

FIG. 18 is a flowchart illustrating a process for generating customer identification data in accordance with an illustrative embodiment. The process is implemented by smart detection system 900 in FIG. 9. The process makes a determination as to whether images of the customer's face are received (step 1802). If images are received, the process identifies the customer using facial recognition to form the customer identification data (step 1804). The process makes a determination as to whether audio of a customer's voice is received (step 1806). If audio is received, the process identifies the customer using voice recognition to form the customer identification data (step 1808) with the process terminating thereafter.

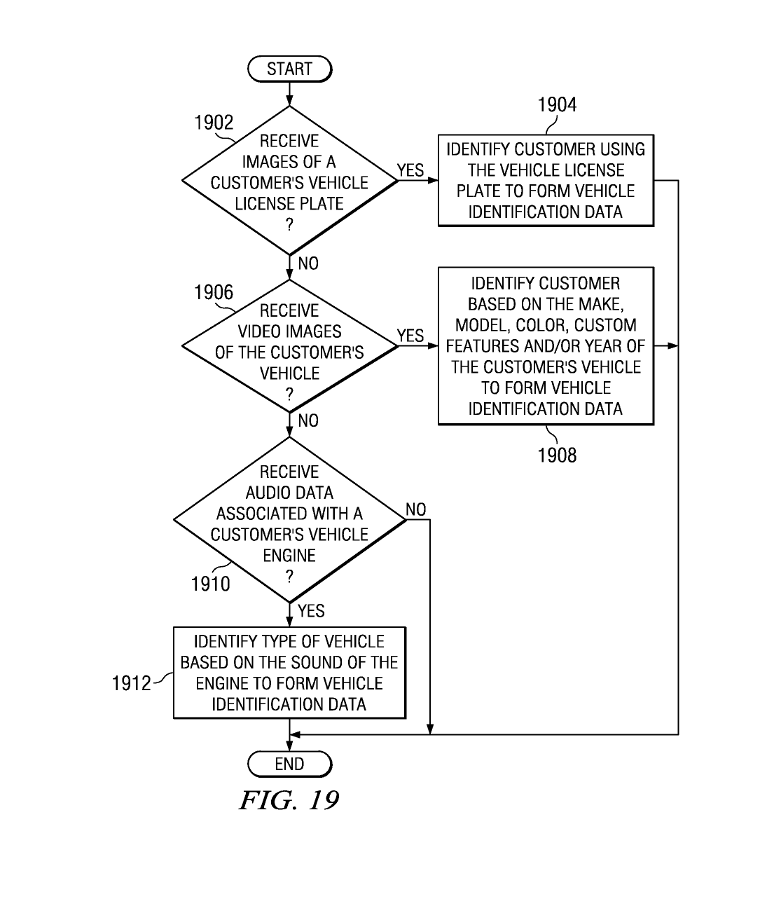

FIG. 19 is a flowchart illustrating a process for generating customer identification data using vehicle data in accordance with an illustrative embodiment. The process is implemented by smart detection system 900 in FIG. 9. The process makes a determination as to whether images of a customer's vehicle license plate are received (step 1902). If images are received, the process identifies the customer using the vehicle license plate to form the vehicle license plate data (step 1904) with the process terminating thereafter.

The process makes a determination as to whether video images of the customer's vehicle are received (step 1906). If video images are received, the process identifies the customer based on the make, model, year, and/or custom features of the customer's vehicle to form the vehicle identification data (step 1908) with the process terminating thereafter.

The process makes a determination as to whether audio data associated with the customer's vehicle engine is received (step 1910). If audio data is received, the process identifies the type of vehicle based on the sound of the engine to form the vehicle identification data (step 1912) with the process terminating thereafter.

FIG. 20 is a flowchart illustrating a process for generating a project based customized marketing message using dynamic data in accordance with an illustrative embodiment. The process in FIG. 20 is implemented by a server, such as analysis server 402 in FIG. 4.

The process begins by retrieving any available dynamic data and/or customer profile for a customer (step 2004). The dynamic data includes, without limitation, customer identification data, vehicle identification data, customer behavior data, and/or any other dynamic customer data elements.

The process pre-generates or creates in advance, appropriate data models using at least one of a statistical method, data mining method, causal model, mathematical model, marketing model, behavioral model, psychographical model, sociological model, simulations/modeling techniques, and/or any combination of models, data mining, statistical methods, simulations and/or modeling techniques (step 2006). The process analyzes dynamic data and customer profile data using one or more of the appropriate data models to identify a set of personalized marketing message criteria (step 2008). The set of personalized marketing message criteria may include one or more criterion for generating a personalized marketing message.

The process dynamically builds a set of one or more customized marketing messages for at least one item of interest located in the next probable location using the personalized marketing message criteria (step 2010). The process transmits the set of customized marketing messages to a display device associated with the customer (step 2012) for presentation of the marketing message to the customer, with the process terminating thereafter.

Thus, the illustrative embodiments provide a computer implemented method, apparatus, and computer program product for decision tree based marketing to a customer in a retail facility. In one embodiment, the process retrieves a marketing decision tree for the customer in response to identifying a customer associated with the retail facility. The marketing decision tree includes a path through the retail facility that the customer typically follows while shopping and a list of customarily purchased items. A next probable location of the customer is identified using a current location of the customer and the marketing decision tree, wherein the marketing decision tree indicates the most likely path through the retail facility that the customer will follow while shopping based on the current location. A customized marketing message for an item located in the next probable location is presented to the customer.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of computer usable or readable program code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for decision tree based marketing to a customer in a retail facility, the computer implemented method comprising:
responsive to identifying a customer associated with the retail facility, retrieving a marketing decision tree for the customer, wherein the marketing decision tree indicates a set of paths through the retail facility that the customer will most likely follow while shopping;
identifying a next probable location of the customer using a current location of the customer and the marketing decision tree; and
generating a customized marketing message for an item located in the next probable location to the customer.

2. The computer implemented method of claim 1 wherein identifying the next probable location further comprises:
identifying items in a shopping container associated with the customer to form current shopping basket contents;
identifying a past purchase history of the customer, wherein the past purchase history indicates items the customer has purchased in the past;
identifying areas of the retail facility traversed by the customer during a current visit to the retail facility to form currently covered areas; and
comparing the current shopping basket contents, the current location of the customer, the currently covered areas, and a probable path in the set of paths in the marketing decision tree to identify the next probable location, wherein the current shopping basket contents are compared to items purchased in the past purchase history to identify additional items the customer is likely to purchase and locations of the additional items in the retail facility, and wherein the next probable location is a location in the locations of the additional items along the probable path.

3. The computer implemented method of claim 1 further comprising:
receiving images of the customer from a set of three or more cameras associated with the retail facility; and
analyzing the images by a smart detection engine to form dynamic data for the customer, wherein the dynamic data includes the current location of the customer in the retail facility.

4. The computer implemented method of claim 3 wherein analyzing the images further comprises:
receiving a series of images of the customer in the retail facility from a set of cameras to form camera data;
analyzing the camera data to form a three dimensional representation of the retail facility, wherein the camera data is used to identify an x-axis, a y-axis and a z-axis for use in generating the three dimensional representation; and
identifying the current location of the customer using the three dimensional representation of the retail facility.

5. The computer implemented method of claim 1 further comprising:
retrieving a customer behavior profile for the customer, wherein the customer behavior profile comprises metadata describing behavior of the customer while shopping during past visits to the retail facility; and
analyzing the customer behavior profile to identify a most probable path in the marketing decision tree.

6. The computer implemented method of claim 1 further comprising:
responsive to a failure of a prediction of a next probable location of the customer by the marketing decision tree, identifying a new current location of the customer and identifying a next most probable location based on the new current location of the customer and the next most likely path through the retail facility indicated by the marketing decision tree, wherein the failure of the prediction of the marketing decision tree is indicated by the customer failing to move to the next probable location designated on the marketing decision tree.

7. The computer implemented method of claim 1 further comprising:
responsive to the customer concluding a transaction at the retail facility to form a most recent transaction, updating the marketing decision tree using a path through the retail facility taken by the customer during the most recent transaction.

8. The computer implemented method of claim 1 further comprising:
presenting a customized marketing message to the customer for an item, wherein the item is located in the current location of the customer.

9. The computer implemented method of claim 1 further comprising:
retrieving a customer behavior profile for the customer, wherein the customer behavior profile comprises grouping data for the customer while shopping in past transactions at the retail facility, wherein the grouping data identifies a grouping category for the customer, and wherein the grouping category is selected from a group consisting of parents with children, teenagers, children, minors unaccompanied by adults, minors accompanied by adults, grandparents with grandchildren, senior citizens, couples, friends, coworkers, a customer shopping with a pet, and a customer shopping alone;
identifying a current grouping category for the customer based on current companions of the customer; and
analyzing the customer behavior profile and current grouping category to generate the marketing decision tree, wherein the marketing decision tree comprises a path through the retail facility that the customer typically follows while shopping with the current grouping category.

10. The computer implemented method of claim 1 further comprising:
receiving data associated with the customer from a set of cameras associated with a retail facility to form detection data for the customer;
processing the detection data, by a smart detection engine, to generate identification data for the customer, wherein the identification data identifies the customer;
retrieving a customer profile for the customer using the customer identification data, wherein the customer profile comprises items purchased during past transactions, previous purchasing patterns, and customer behavior while shopping; and
analyzing the customer profile to generate the marketing decision tree.

11. The computer implemented method of claim 1 further comprising:
retrieving a customer behavior profile for the customer wherein the customer behavior profile indicates customer behavior while shopping in past transactions, and wherein the customer behavior includes at least one of an average speed of walking through the retail facility, a typical time of day for shopping, a typical day of the week for shopping, a frequency of visits to the retail facility over a given time period, an average amount of time spent selecting each item that is purchased, an average number of items purchased during each transaction, and an average number of shopping companions accompanying the customer; and
analyzing the customer behavior profile to generate the marketing decision tree.

12. The computer implemented method of claim 1 further comprising:
receiving data associated with a customer from a set of detectors associated with the retail facility to form detection data;
processing the detection data to form dynamic data for the customer;
analyzing the dynamic data using a set of data models to identify personalized marketing message criteria for the customer;
generating the customized marketing message using the personalized marketing message criteria, wherein the customized marketing message comprises a marketing offer associated with an item in the next probable location; and
delivering the customized marketing message to a display device associated with the customer for display of the customized marketing message to the customer.

13. A computer program product comprising:
a computer usable medium including computer usable program code for decision tree based marketing to a customer in a retail facility, said computer program product comprising:
computer usable program code for retrieving a marketing decision tree for the customer, wherein the marketing decision tree indicates a set of paths through the retail facility that the customer will most likely follow while shopping in response to identifying a customer associated with the retail facility;
computer usable program code for identifying a next probable location of the customer using a current location of the customer and the marketing decision tree; and
computer usable program code for generating presenting a customized marketing message for an item located in the next probable location to the customer.

14. The computer program product of claim 13 wherein identifying a next probable location further comprises:
computer usable program code for identifying items in a shopping container associated with the customer to form current shopping basket contents;
computer usable program code for identifying a past purchase history of the customer, wherein the past purchase history indicates items the customer has purchased in the past;
computer usable program code for identifying areas of the retail facility traversed by the customer during a current visit to the retail facility to form currently covered areas; and
computer usable program code for comparing the current shopping basket contents, the current location of the customer, the currently covered areas, and a probable path indicated in the marketing decision tree to identify the next probable location, wherein the current shopping basket contents are compared to items purchased in the past purchase history to identify additional items the customer is likely to purchase and locations of the additional items in the retail facility, and wherein the next probable location is a location in the locations of the additional items along the probable path.

15. The computer program product of claim 13 further comprising:
computer usable program code for retrieving a customer behavior profile for the customer, wherein the customer behavior profile comprises metadata describing behavior of the customer while shopping during past visits to the retail facility; and
computer usable program code for analyzing the customer behavior profile to generate the marketing decision tree.

16. The computer program product of claim 13 further comprising:
computer usable program code for identifying a new current location of the customer and identifying a next most probable location based on the new current location of the customer and the set of paths in the marketing decision tree in response to a failure of a prediction of the decision tree, wherein the failure of the prediction of the decision tree is indicated by the customer failing to move to the next probable location designated by the marketing decision tree.

17. The computer program product of claim 13 further comprising:
computer usable program code for updating the marketing decision tree using a path through the retail facility taken by the customer during a most recent transaction in response to the customer concluding a transaction at the retail facility to form the most recent transaction.

18. The computer program product of claim 13 further comprising:
computer usable program code for presenting a customized marketing message to the customer for an item, wherein the item is located in the current location of the customer.

19. The computer program product of claim 13 further comprising:
computer usable program code for retrieving a customer behavior profile for the customer, wherein the customer behavior profile comprises grouping data for the customer while shopping in past transactions at the retail facility, wherein the grouping data identifies a grouping category for the customer, and wherein the grouping category is selected from a group consisting of parents with children, teenagers, children, minors unaccompanied by adults, minors accompanied by adults, grandparents with grandchildren, senior citizens, couples, friends, coworkers, a customer shopping with a pet, and a customer shopping alone;
computer usable program code for identifying a current grouping category for the customer based on current companions of the customer; and
computer usable program code for analyzing the customer behavior profile and current grouping category to generate the marketing decision tree, wherein the decision tree comprises a path through the retail facility that the customer typically follows while shopping with the current grouping category.

20. The computer program product of claim 13 further comprising:
computer usable program code for receiving data associated with the customer from a set of cameras associated with a retail facility to form detection data for the customer;
computer usable program code for processing the detection data, by a smart detection engine, to generate identification data for the customer, wherein the identification data identifies the customer;
computer usable program code for retrieving a customer profile for the customer using the customer identification data, wherein the customer profile comprises items purchased during past transactions, previous purchasing patterns, and customer behavior while shopping; and
computer usable program code for analyzing the customer profile to generate the marketing decision tree.

21. A data processing system for decision tree based marketing to a customer in a retail facility, the data processing system comprising:
a bus system;
a communications system connected to the bus system;
a memory connected to the bus system, wherein the memory includes computer usable program code; and
a processing unit connected to the bus system, wherein the processing unit executes the computer usable program code to retrieve a marketing decision tree for the customer in response to identifying a customer associated with the retail facility, the marketing decision tree indicates a set of paths through the retail facility that the customer will most likely follow while shopping; identify a next probable location of the customer using a current location of the customer and the marketing decision tree; and generate presenting a customized marketing message for an item located in the next probable location to the customer.

22. The data processing system of claim 21 wherein the processor unit further executes the computer usable program code to identify items in a shopping container associated with the customer to form current shopping basket contents; identify a past purchase history of the customer, wherein the past purchase history indicates items the customer has purchased in the past; identify areas of the retail facility traversed by the customer during a current visit to the retail facility to form currently covered areas; and compare the current shopping basket contents, the current location of the customer, the currently covered areas, and a probable path indicated in the marketing decision tree to identify the next probable location, wherein the current shopping basket contents are compared to items purchased in the past purchase history to identify additional items the customer is likely to purchase and locations of the additional items in the retail facility, and wherein the next probable location is a location in the locations of the additional items along the probable path.

23. A system for decision tree based marketing to a customer in a retail facility, the system comprising:
an analysis server, wherein the analysis server identifies a customer associated with the retail facility; retrieves a marketing decision tree for the customer, the marketing decision tree indicates a set of paths through the retail facility that the customer will most likely follow while shopping; and identifies a next probable location of the customer using a current location of the customer and the marketing decision tree; and
a dynamic marketing message assembly, wherein the dynamic marketing message assembly generates a customized marketing message for an item located in the next probable location to the customer.

24. The system of claim 22 further comprising:
a set of cameras associated with the retail facility, wherein the set of cameras captures images of the customer in the retail facility; and
a smart detection engine, wherein the smart detection engine analyzes the images to form dynamic data for the customer, wherein the dynamic data includes a current location of the customer in the retail facility.

25. The system of claim 23 further comprising:
a decision tree generator, wherein the decision tree generator generates the marketing decision tree for the customer using current shopping basket contents, a past purchase history of the customer, wherein the past purchase history indicates items the customer has purchased in the past, and a current location of the customer.
